(19) United States
(12) Patent Application Publication
(10) Pub. No.: US 2023/0205824 A1
(43) Pub. Date: Jun. 29, 2023

(54) Contextual Clarification and Disambiguation for Question Answering Processes

(71) Applicant: Pryon Incorporated, Raleigh, NC (US)

(72) Inventors: Igor Roditis Jablokov, Raleigh, NC (US); Vaibhava Goel, Chappaqua, NY (US); David Nahamoo, Great Neck, NY (US); Marie Wenzel Meteer, Arlington, MA (US)

(21) Appl. No.: 18/083,733

(22) Filed: Dec. 19, 2022

Related U.S. Application Data
(60) Provisional application No. 63/293,343, filed on Dec. 23, 2021.

(51) Int. Cl. G06F 16/93

(52) U.S. Cl. CPC G06F 16/93

(57) ABSTRACT

Disclosed are methods, systems, devices, apparatus, media, and other implementations, including a method that includes receiving query data representative of a question relating to source content of one or more source documents, and causing a search of a data repository maintaining data portions relating to the one or more source documents to determine a set of multiple matches between the query data and the data portions. The method additionally includes identifying one or more concepts associated with the set of multiple matches, with at least one of the identified concepts being associated with at least some of the multiple matches and including different respective values associated those some of the multiple matches, obtaining disambiguation information relevant to the at least one of the identified concepts, and selecting at least one of the multiple matches based on the obtained disambiguation information.

### CROSS REFERENCE TO RELATED APPLICATIONS

This application claims priority to U.S. Provisional Application No. 63/293,343, filed Dec. 23, 2021, the contents of which are herein incorporated by reference.

### BACKGROUND

This invention relates to question-answer systems to generate responses to queries submitted by a user, and in particular to an approach to facilitate identification of relevant answers to the queries through determination of disambiguation information.

Computer users often have access to vast amounts of data, whether accessible through public networks (such as the Internet) or private networks, that the users can a search to find answers and information to specific or general queries about some topic or issue. For example, organizations often collect large number of documents to service as a repository of information, be it administrative of technical information, that the organization's employees may access and perform searches on. For example, a corporation may have a large library of human resource documents, which together define, in a hopefully consistent manner, the HR policies and procedures of the corporation. A user, such as a corporate employee, can search the collection of documents to answer a question, such as “how much vacation time am I entitled to?”

Depending on the level of specificity of a submitted query, the question-answer system may produce a large number of search results (even when the Q-A system performs some initial filtering to eliminate responses that do not meet minimal relevance criteria). The user might then be presented with an unwieldly large number of possible answers whose actual relevance and responsiveness to the submitted query can only be ascertained by reading through the answers, whether by reading short snippets or summaries presented on a search result user interface, or accessing an underlying document associated with a result.

### SUMMARY

The present disclosure is directed to a question answering system configured to identify concepts (abstractions descriptive of the content, metadata information, entity identifiers information, etc.) associated with answer results returned by the question answering system, and determine disambiguation information to help whittle down the number of answers through elimination of answers deemed to be less relevant than other of the returned answers in view of the disambiguation information. The disambiguation information may be generated automatically based on available contextual information (entity names, abstracted concepts derived for ingested content segments, and so) that is processed by the question-answering system, or may be obtained through dynamic interaction, facilitated by the question-answering system, that causes the user to provide additional information, e.g., in the form of responses to inquiries generated, based on the identified concepts, by the Q-A system, that can be used to disambiguate the available answers and remove less relevant answers.

The identification of relevant concepts can be performed by the Q-A system based on contextual information associated with the answer results generated in response to the query (e.g., contextual information that was preserved during initial ingestion and processing of source documents into Q-A searchable content), and based on other available contextual information (e.g., information associated with the user, information relating to a previously submitted query and so on). The identification of concepts can be implemented through a learning machine configured to identify/distill concepts from search results (or portions thereof). As will be discussed in greater detail below, two answers may be deemed to be ambiguous (and thus to require disambiguation in order to resolve the existing ambiguity) when those two answers are determined to be associated with the same or similar concept, but have different (conflicting) concept values.

Advantageously, the proposed approaches and solutions described herein avoid the need to populate searchable content with an exhaustive set of metadata that captures a large universe of possible contexts in for which the content may be used or searched (because such expansive context information is just too hard to bake in, and it is hard to predict what pieces of information will ultimately be useful for disambiguation). The proposed approaches and solutions implement an efficient framework that includes a disambiguation stage that follows a searching stage (to execute queries on previously ingested content).

Thus, in some variations, a method is provided that includes receiving, at a local device from a remote device, query data representative of a question relating to source content of one or more source documents, and causing a search of a data repository maintaining data portions relating to the one or more source documents to determine a set of multiple matches between the query data and the data portions maintained at the data repository. The method additionally includes identifying one or more concepts associated with the set of multiple matches, at least one of the one or more identified concepts being associated with at least some of the multiple matches and including different respective values associated with the at least some of the multiple matches, obtaining disambiguation information relevant to the at least one of the one or more identified concepts, and selecting at least one of the multiple matches based on the obtained disambiguation information relevant to the at least one of the one or more identified concepts.

Embodiments of the method may include at least some of the features described in the present disclosure, including one or more of the following features.

Obtaining the disambiguation information may include obtaining query contextual information for recent query transactions performed in relation to the source content, and selecting at least one of the multiple matches may include selecting at least one of the multiple matches based, at least in part, on the query contextual information for the recent query transactions performed in relation to the source content.

Obtaining the disambiguation information may include generating prompt data to prompt a user to provide clarification information, and selecting at least one of the multiple matches may include selecting at least one of the multiple matches based, at least in part, on the clarification information provided by the user in response to the generated prompt data.

Generating the prompt data to prompt the user to provide the clarification information may include automatically generating an output prompt based on one or more of, for example, generating a list with selectable items corresponding to different values for one or more context categories, applying natural language processing to the identified multiple matches to generate a prompt with a list of selectable items from which the user is to select one or more of the selectable items, and/or selecting from a set of pre-determined prompts one or more items.

Selecting at least one of the multiple matches may include excluding, based on the clarification information provided by the user, one or more of the multiple matches. In such embodiments, the method may further include iteratively generating refined prompt data, based on non-excluded matches from the set of identified matches, to prompt the user to iteratively provide further clarification information to identify an optimal match from the identified multiple matches.

Generating the prompt data may include rendering a graphical representation of a map to prompt the user to indicate a geographical location, and selecting the at least one of the multiple matches based, at least in part, on the clarification information may include selecting the at least one of the multiple matches in response to the at least one of the multiple matches determined to be relevant to the geographical location indicated by the user.

Each of multiple matches may be associated with content contextual information associated with the data portions maintained at the data repository. Identifying the one or more concepts associated with the multiple matches may include identifying the one or more concepts based, at least in part, on the content contextual information associated with the each of the multiple matches.

The content contextual information associated with the respective data portions may be generated by one or more of, for example, a) applying one or more pre-processes to the one or more source documents to produce document contextual information representative of a structure and content of the one or more source documents, and transforming the one or more source documents, based on the contextual information, to generate one or more question-and-answer searchable documents, b) segmenting the one or more source documents into a plurality of document segments, identifying, for at least one segment of the plurality of document segments, at least one segment descriptor comprising one or more of at least one entity associated with the at least one segment, at least one task associated with at least one segment, or subject matter descriptor associated with the at least one segment, and tagging the at least one segment with the at least one descriptor, and/or c) adding user annotations to one or more of the data portions.

The content contextual information for each of the multiple matches may include data representative of values for a plurality of context categories, and identifying the one or more concepts associated with the multiple matches may include determining whether at least two of the multiple matches are associated with different values for a particular context category from the plurality of context categories.

Causing the search of the data repository to determine the set of matches between the query data and the data portions maintained at the data repository may include arranging the matches in the set of matches into groups that each share one or more of the plurality of context categories.

The query data may include query contextual data, and causing the search of the data repository to determine the set of matches may include causing the search of the data repository to identify data portions associated with the query contextual data included in the query data.

The query contextual data may include geographical location data specified by the user through a graphical representation of a map, and selecting the at least one of the multiple matches based, at least in part, on the disambiguation information may include causing the search of the data repository to identify data portions relevant to the geographical location data specified by the user.

The query contextual data may include category data specifying one or more categories from a plurality of context categories, and causing the search of the data repository may include causing the search of the data repository to identify matches associated with the specified one or more categories from the plurality of context categories specified in the query contextual data.

The data portions maintained at the data repository may include transformed portions of the source content transformed according to one or more content transformation procedures, and causing the search of the data repository maintaining the data portions may include transforming the query data into transformed query data compatible with the transformed source content, and searching the transformed content maintained at the data repository to identify one or more candidate portions in the transformed content matching, according to one or more criteria, the transformed query data.

The transformed portions of the source content may include data portion transformed according to Bidirectional Encoder Representations from Transformers (BERT) processing.

The one or more transformations may include one or more of, for example, a coarse linearization transform to generate coarse numerical vectors representative of content of a plurality of document segments of the source content, or a fine-detail transformation to generate fine-detail transformed content records representative of the content of the plurality of document segments.

Obtaining the disambiguation information relevant to the at least one of the one or more identified concepts may include obtaining the disambiguation information according to one of, for example, i) a first disambiguation policy specifying a pre-determined order of multiple concepts, selected from the one or more identified concepts, for which relevance of the multiple matches to the respective multiple concepts is determined, ii) a second disambiguation policy for selecting a concept from the one or more identified concepts that optimizes an objective function to reduce level of ambiguity among the multiple matches, and/or iii) a third disambiguation policy to visually prompt a user for feedback related to the one or more identified concepts, for selecting the at least one of the multiple matches.

In some variations, a system is provided that includes a communication unit configured to receive, from a remote device, query data representative of a question relating to source content of one or more source documents, and a controller electrically coupled to the communication unit. The controller is configured to cause a search of a data repository maintaining data portions relating to the one or more source documents to determine a set of multiple matches between the query data and the data portions maintained at the data repository, identify one or more concepts associated with the multiple matches, at least one of the one or more identified concepts being associated with at least some of the multiple matches and including different respective values associated with the at least some of the multiple matches, obtain disambiguation information relevant to the at least one of the one or more identified concepts, and select at least one of the multiple matches based on the obtained disambiguation information relevant to the at least one of the one or more identified concepts.

In some variations, a non-transitory computer readable media is provided, that is programmed with instructions, executable on one or more processors of a computing system, to receive, at a local device from a remote device, query data representative of a question relating to source content of one or more source documents, and cause a search of a data repository maintaining data portions relating to the one or more source documents to determine a set of multiple matches between the query data and the data portions maintained at the data repository. The instructions further cause the computing system to identify one or more concepts associated with the multiple matches, at least one of the one or more identified concepts being associated with at least some of the multiple matches and including different respective values associated with the at least some of the multiple matches, obtain disambiguation information relevant to the at least one of the one or more identified concepts, and select at least one of the multiple matches based on the obtained disambiguation information relevant to the at least one of the one or more identified concepts.

In certain variations, a computing apparatus is provided that includes a communication unit configured to receive, from a remote device, query data representative of a question relating to source content of one or more source documents, and one or more programmable devices to perform question answering processes according to any of the method steps described above.

In certain variations, a non-transitory computer readable media is provided that is programmed with a set of computer instructions executable on a processor that, when executed, cause the operations comprising any of the various method steps described above.

Embodiments of the above system, apparatus, and/or the computer-readable media may include at least some of the features described in the present disclosure, and may be combined with any other embodiment, variation, or feature of the method.

Other features and advantages of the invention are apparent from the following description, and from the claims.

### BRIEF DESCRIPTION OF THE DRAWINGS

These and other aspects will now be described in detail with reference to the following drawings.

FIG. 1 is a diagram of an example Question-and-Answer document processing and response generation system.

FIG. 2 is a flow diagram for a framework to determine disambiguation information for use during execution of a query (for a Q-A system).

FIG. 3 is a diagram of an example document ingestion procedure.

FIG. 4 is a flowchart of a procedure for contextual clarification and disambiguation for question answering processes.

Like reference symbols in the various drawings indicate like elements.

### DESCRIPTION

Disclosed are implementations for a question-and-answer system (also referred to as a question-answering system or Q-A system) that dynamically determines disambiguation information used for assessing relevance of query/search results, and selects or excludes search results based on the determined disambiguation information. The disambiguation information can be determined through an interactive process (visual/graphic, text and/or spoken interaction) to solicit from the user feedback that can resolve result ambiguity between multiple answers (or groups/clusters of answers) produced for a particular query, and/or through acquisition of contextual information related to the query and/or the various answers that were generated in response to the query.

The solutions and approaches proposed herein include processes that begin by adding metadata to unstructured content to indicate the contexts in which the information is relevant. For example, for HR data, an employee's status and state where the employee resides may be required to answer specific questions about medical leave. This information might be implicit, for example, in the path of a URL or file. It might be separated from the text which answers the question, for example in the document title or section headings. It can also be extracted from the document content based on guidance provided by the content manager. When a user asks a question and the answers are returned, contextual information from the valid answers is collected. In some examples, the implementations may determine what information (e.g., resolving conflicts between values of contextual elements), if available, might disambiguate the answers, and the user may be queried to determine such information so that the answers are more particularly selected to be relevant to their needs at that time. The disambiguation queries (or questions) may be a set of multiple values (presented visually) from which the user is asked to select one or more, a question automatically generated by the system, or a question selected from a set that has already been developed for the domain. This approach of interactively providing a set of disambiguation queries to the user that is collected from the set of valid answers themselves efficiently communicate to the user what information is needed to get the best answer(s).

The proposed approaches can be thought of as a hybrid interactive system which combines methods associated with unstructured Q-A search over the content itself with structured search, using dialog to direct the search of the metadata associated with the content, in order to achieve better and more relevant results. These approaches achieve the technical solution of dynamic disambiguation of search results in part by adding structured metadata to unstructured data, determining contextual information (abstracted concepts or categories) required by inspecting the metadata in a set of valid responses, and using this metadata to guide a clarification dialog to get the user to the most relevant response to the user's question.

Thus, the proposed approaches include a method including receiving, at a local device from a remote device, query data representative of a question relating to source content of one or more source documents, and causing a search of a data repository maintaining data portions relating to the one or more source documents to determine a set of multiple matches between the query data and the data portions maintained at the data repository. The method further includes identifying one or more concepts associated with the multiple matches, with at least one of the one or more identified concepts being associated with at least some of the multiple matches and including different respective values associated with the at least some of the multiple matches, obtaining disambiguation information relevant to the at least one of the one or more identified concepts, and selecting at least one of the multiple matches based on the obtained disambiguation information relevant to the at least one of the one or more identified concepts. As noted, disambiguation information may be determined based on available contextual information, including contextual information associated with the query itself or with previously submitted queries, relying on correlation between temporal proximate queries or spatial-proximate queries (e.g., queries submitted from the same terminal), and so on. As also noted, disambiguation information can be determined by interacting with the user to prompt the user to provide clarifying information (e.g., by presenting a user with a list with selectable options). The clarification information can then be used to select or exclude one or more of the multiple generated answers to the query, and the process can be iteratively applied to a refined set of answers until the initial set of answers is culled to some threshold number of answers (e.g., one answer, two answers, or any other number of answers).

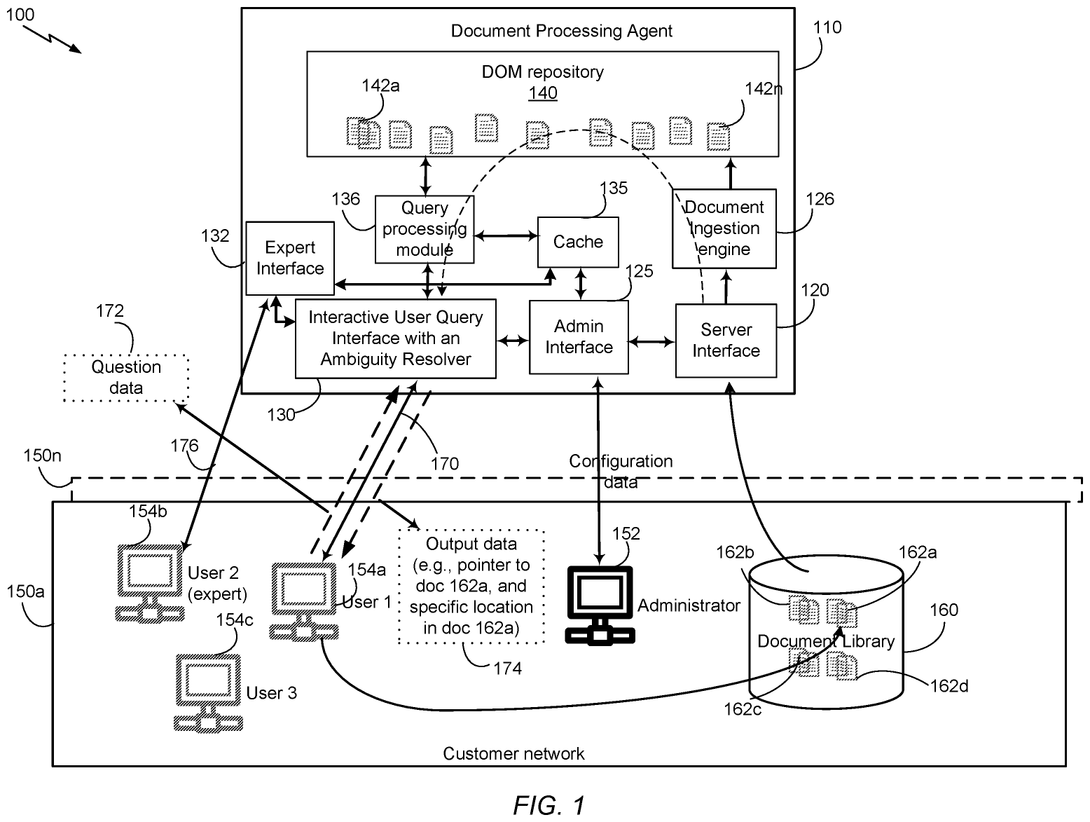

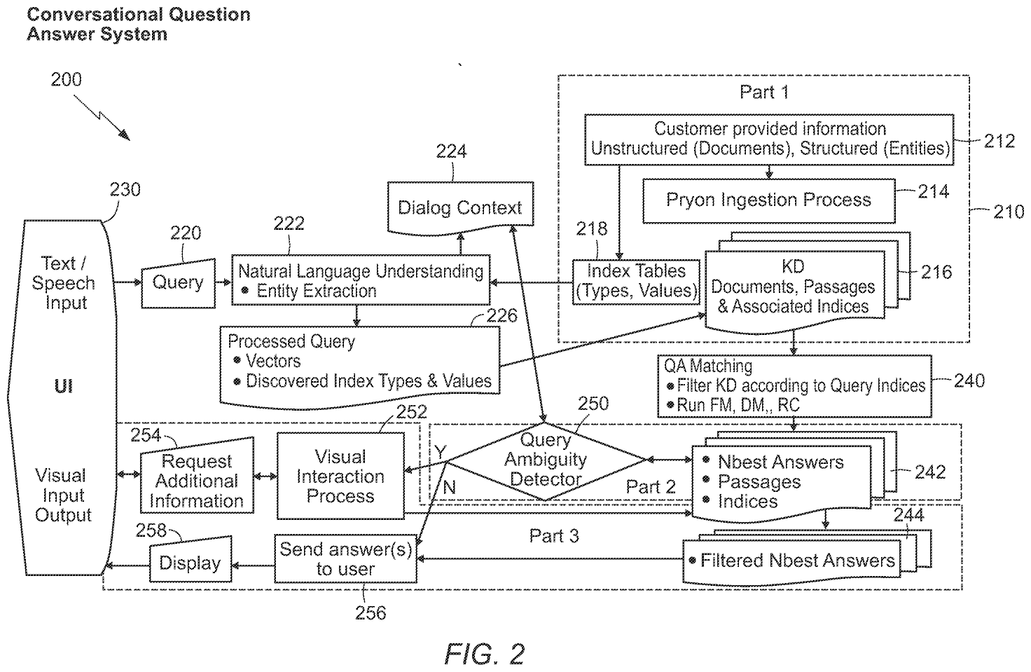

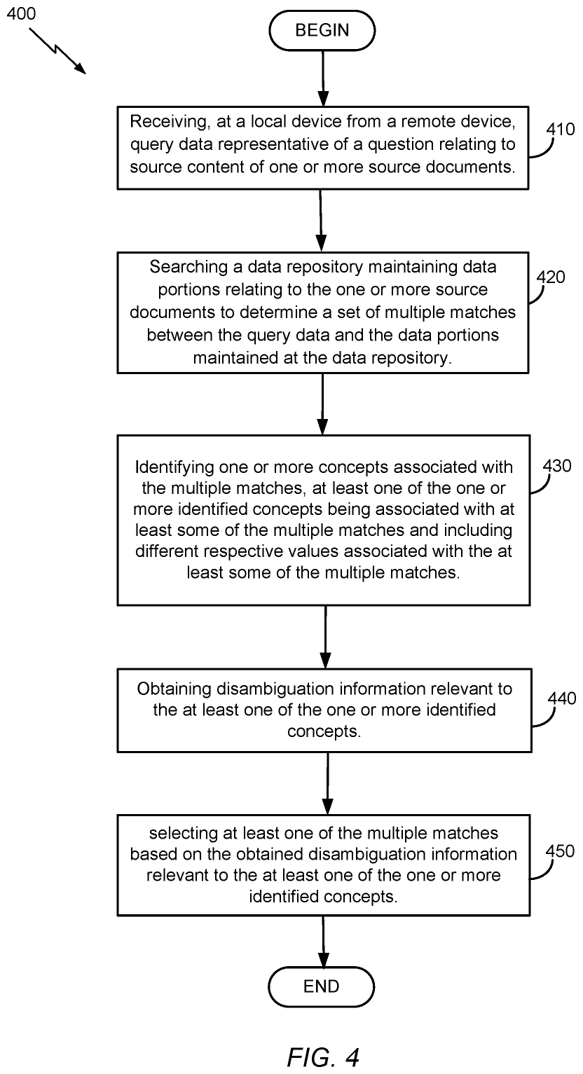

The approaches and solutions described herein may be implemented on any computing framework with searching capabilities (in the form of question-and-answers, or otherwise). For the sake of illustration only, and without limitation, some example embodiments of the present approaches and solutions will be discussed in relation to the architecture depicted in FIG. 1, and which will be discussed in greater detail below. The discussion of the example Q-A framework used to illustrate the embodiments of the dynamic disambiguation approaches will then be followed by a more detailed discussion of the dynamic disambiguation approaches (provided with reference to FIGS. 2 and 4).

### Example Question-and-Answer System Architecture

With reference to FIG. 1, a diagram of an example system 100 for document processing and response generation, is provided. Further details regarding the system 100 are provided in international application No. PCT/US2021/039145, entitled “DOCUMENT PROCESSING AND RESPONSE GENERATION SYSTEM,” the content of which is hereby incorporated by reference in its entirety.

The system 100 is configured to ingest source documents (e.g., a customer's voluminous library of documents, or other repositories of data such as e-mail data, collaborative platform data, etc.) to transform the documents to document objects (referred to as document object model, or DOM, documents) that represent a mapping from the source documents to searchable resultant objects (resultant transformed) documents. Those document objects may be stored in a DOM repository (also referred to as knowledge distillation, or KD, repository). A user associated with the customer that provided that document library (e.g., an employee of the customer) can subsequently submit a query (e.g., a natural language query, such as “how many vacation days does an employee with 2 years seniority get a year?”) that is processed by the system 100, and, in situations where a quick answer is not otherwise available from a cache for commonly-asked-questions, the query is processed and transformed into a format compatible with the format of ingested documents to identify portions in one or more of the ingested documents that may contain the answer to the user's query. The system then returns, to the user, output data that includes for example, a pointer to a location within one or more of the source documents (corresponding to the identified one or more ingested documents) which the user then accesses directly to retrieve an answer to the query. The output may alternatively, or additionally, include, in some embodiments, the answer to the user's query and/or a portion of a document, e.g., a paragraph, that contains the answer. Advantageously, the output returned to the user does not need to (although, in some examples, it may, if desired) include the specific information sought by the user, but rather just includes a pointer to a portion of source document stored in a secured site that cannot be accessed by parties not authorized to access that source document. This answer-determination approach therefore enhances the security features of transmitting sensitive information (e.g., confidential or private). As discussed herein, in situations where a query produces multiple answers (some of which may have conflicting values), the output may include dynamically generated prompts asking the user to provide feedback to resolve ambiguity in the returned answers.

In some embodiments, searching the document object repository to find an answer to a query typically includes two operations: (1) first, a process referred to as Fast-Search or Fast Match (FM) process is performed, and (2) the Fast-Match process is then followed by a process called Detailed-Search or Detailed-Match (DM) process (also referred to herein as “fine-detail” search). Both the FM and DM processes can be based on BERT (Bidirectional Encoder Representations from Transformers) models. In the FM case, the model results (in some implementations) in, for example, one vector for a query and one vector for one paragraph (e.g., 200 words window, which may also include contextual data). In the DM, there are typically multiple vectors per query or per paragraph, in proportion to the number of, for example, words or sub-words, in the query or paragraph.

It is to be noted that, in some embodiments, the transformations of the query and/or the source documents may be performed at a customer's network, with the transformed query and/or transformed content then communicated to a central server. Such embodiments can improve privacy and security for communicating sensitive data across networks since resultant vectors (derived through the transformation of content or query data) are created in the secure space of the customer (client), and consequently only the resultant transformed vectors (rather than the actual content or query data) are available or present at the centralized cloud server. The transformation of the content or query data at the client's device can act as a type of encryption applied to the data being transformed and will thus result in secure processing that protects the data from attacks on the server cloud. In some embodiments, the data being transformed at the client's network can additionally be encrypted to provide even further enhanced secured communication of the client's data (be it source data or query data).

As depicted in FIG. 1, the system 100 typically includes a document processing agent 110 (which may be an AI-based agent) in communication with a customer's network 150a (which is one of n customer networks/systems that access, in the example system 100, the document processing agent 110). The document processing agent 110 can be implemented as an independent remote server that serves multiple customers like the customer systems 150a and 150n, and can communicate with such customers via network communications (be it private or public networks, such as the Internet). Communication with customers' units is realized via a communication unit comprising one or more communication interfaces (such as a server interface 120, an admin interface 125, an interactive user query interface with ambiguity resolver 130, and/or expert interface 132, all of which are represented schematically in FIG. 1), which would generally include communication modules (e.g., transceivers for wired network communications and/or for wireless network communication, with such transceivers configured according to various appropriate types of communication protocols). Alternatively, the document processing agent 110 does not need to be located at a remote location, but may be a dedicated node within the customer network (for example, it can be implemented as a process running on one of the customer's one or more processor-based devices, or may be a logical remote node implemented on the same computing device as a logical local node; it is to be noted that the term “remote device” can refer to the customer station, while “local device” can refer to the document processing agent 110, or vice versa). An arrangement where the agent 110 executes out of the customer's network (such as any of the customer networks 150a-n) may improve data security, but may be more expensive to privately run.

Yet in other alternative embodiments, some portions of the system (e.g., the ingestion units configured to perform the pre-processing and vectorization (parametrization) operations on source documents and/or on queries submitted by users) may be located inside the firewall of a customer's network, while storage of ingested document (and optionally search engines to search ingested content) may be located outside the customer's network's firewall (e.g., on a centralized cloud server(s)). In such alternative embodiments, data sent to the cloud servers (e.g., to perform the search at a centralized location) may already have been processed into encoded (ingested) content (e.g., through vector processing that may have been implemented through coarse transform, e.g., applied to fixed sized input segments, and/or fine-detail numerical transforms applied to smaller portions than the portions processed by the coarse transformer) that is unintelligible to third parties unauthorized to make use of the data, thus adding another measure of privacy and security protection to data that is to be processed using the system 100. In these alternative embodiments, the initial part of the processing of the input query may also be processed inside the customer network's firewall. In addition to performing the transformation (of the source content and/or the query) within a client's firewall, such transformed data may further be encrypted (using symmetric or asymmetric encryption keys) before being transmitted to the document processing agent 110, thus increasing the level of security/privacy realized for communications between a customer's network and the centralized document processing agent (which serves multiple customers).

The example customer network 150a may be a distributed set of stations, potentially with a dedicated secured gateway (protected by a firewall and/or other security measures) that can be controlled (from a station 152) by an administrator. The customer generally has amassed a large volume of electronic documents (including, e.g., technical documentation relevant to the customer's operations, administrative documents such as Human Resource documents, and all other types of written documents in electronic form). The documents are arranged in a document library 160 (which may be part of the computing of the customer network 150a), and are accessible by various authorized users at user stations 154a-c within the network 150a, and by an administrator (via an administrator station 154). Any number of stations may be deployed in any particular customer network/system. The administrator station 152 can control access to the documents in the library 160 by controlling privileges, and otherwise managing the documents (e.g., access to specific documents within the library 160, management of content to conceal portions that do not comply with privacy requirements, etc.) As will be discussed in greater detail below, in addition to the library 160 (containing documents relating to operation of the entity operating on the network), other sources of data or information may be available from various applications employed by the customer (e.g., an e-mail application, a chat application such as Slack, customer relationship applications such as Salesforce, etc.) to process through the document processing implementations described herein.

The administrator station 152 is configured to communicate with the document processing agent 110 via, for example, an admin interface 125. Among other functions, the administrator can provide the document processing agent 110 with information identifying location of the source document in the repository (library) 160 maintaining the plurality of source documents, control configuration and operation of the functionality of the document processing agent 110 in relation to the customer network 150a, review data produced by the agent 110 (e.g., override certain answers), provide the document processing agent 110 with training data, etc. Communication between the station 152 and the admin interface 125 can be established based on any communication technology or protocol. To enhance security features, communications between the document processing agent 110 and the administrator station 152 may include authentication and/or encryption data (e.g., using symmetric or non-symmetric encryption keys provided to the document processing agent 110 and the administrator station 152). Using the communication link established between the administrator station 152 and the interfaces 120 and 125, the administrator provides information necessary for the document processing agent 110 to access the document library. For example, the administrator station can send a message providing the document processing agent 110 with a network address for the document library 160 (and/or identity of documents within that library that the agent 110 is to access and process). The administrator station can, in turn, receive an encryption key (e.g., a private symmetric key, or a public key corresponding to a private asymmetric key used by the agent 110) that is to be used to encrypt content of documents that are to be transferred to the agent 110. The communication between the administrator station 152 and the admin interface 125 (or any of the other interfaces, such as interfaces 120 and 130, with which the administrator can communicate) can also be used to establish other configuration settings controlling the exchanges of data and information between the customer network 150a and the document processing agent 110, as will be described in greater detail below.

Once the document processing agent has been provided with the location (e.g., represented as a network address) of the document library 160, and the communication features controlling the transmission of data between the customer network 150a and the agent 110, the agent 110 can begin receiving data transmissions of the documents from the repository (library) 160. The administrator station 152 can control the content sent, and perform some pre-transmission processing on the documents to be sent to the document processing agent 110, including removing sensitive content (e.g., private details), encrypting the content (e.g., using a public key corresponding to a private key at the document processing agent 110), authenticating the data to be transmitted, etc. The document processing agent 110 receives data transmitted from the customer network 150a via the server interface 120, and performs data pre-processing on the received data, including authentication and/or decryption of the data, format conversion (if needed), etc. The server interface 120 then passes the data corresponding to the documents sent from the document library 160 (subject to any pre-processing performed by the interface 120) to a document ingestion engine 126 that processes the received documents to transform (convert) them into a representation that allows the determination and generation of answers to queries provided by a user of the network 150a. Typically, prior to applying the transformation(s), the source document is segmented into portions (e.g., 200-word portions, or any other word-based segment), with the segmentation performed according to various rules for adjoining content from various parts of the documents into discrete segments. An example of a pre-processing (i.e., pre-transformation) rule is to construct segments using a sliding window of a fixed or variable length that combines one or more headings preceding the content captured by the sliding window, and thus creates a contextual association between one or more headings and the content captured by the window. Such a rule ensures that the transformation performed on a segment combines important contextual information with content located remotely (e.g., farther away in the source document) from the segment being processed.

Having segmented the source document, and/or or performed other types of pre-processing (as will be described in greater detail below), the document ingestion engine 126 is configured to apply one or more types of transformations to the document segments to transform the segments into searchable segments (e.g., question-and-answer searchable segments). One type of transformation that can be applied to the segment is based on transforming the fixed-sized (or substantially fixed-sized) segments, typically comprising multiple words/tokens, into numerical vectors in order to implement a fast-search process. Such a search is typically a coarse search, in that it generally returns (in response to a query submitted by a user) a relatively high number of results (hits) because the search is based on matching vectors produced from input data comprising a relatively large number of words (tokens or features), and as a result the resolution achievable from such a transformation is lower than what can be achieved from transforming smaller segments. Thus, results based on coarse vector transformations might not provide as accurate representations of the textual meaning of the transformed content as other transformations applied on smaller segments. On the other hand, as the name suggests, the fast-search can be performed relatively quickly, and thus may be used to winnow the possible candidates of possible answers (to the submitted query) to a size or number that can then be more carefully searched (possibly through a search based on another type of transformation). Another transformation that may be applied by the ingestion engine is one for generating fine-detail vector transformations that are used to more narrowly pin-point locations of answers with some text-segment (e.g., paragraphs) specific answer word sequences. Generally, document segments on which the fine-detail transformations are applied may be at a finer grain (resolution) than fast-search segments (which are generally of a fixed size, e.g., 200 words, and thus cannot typically pinpoint the exact location of an answer, if one exists, within the segment).

More specifically, a fast-search transformation (e.g., implemented through neural networks, filters, etc.) is applied to the segment to yield vectors with values that are based, and therefore are representative of, the content of the document segments. As will be discussed in greater detail below, several approaches may be applied by the document ingestion engine 126 to transform the data according to the fast-search transformation. In one example, the data representative of the content may be transformed into vector representations (e.g., fixed size vector, or variable size vectors). Thus, in such an example, the transform converts textual content into a vector of numerical values, which may or may not be associated with metadata (e.g., text-based metadata, providing additional information that can be used for further processing) or other contextual information. The resultant transformed vector can be representative of possible questions and answers that are associated with the input segment that was transformed. An example of a transformation that yields such vector-value representative of the content of the input (including contextual relationships) is the Bidirectional Encoder Representation from Transformers (BERT)

For the fine-detail transformation performed by the document ingestion engine 126, the source data (e.g., text-based portions segmented from a source document according to one or more rules or criteria, with the segmented portions typically being smaller in size than the source segments used for the fast-search transformation) is typically transformed into multiple vectorized (numerical/parametrized) transformed content. The fine-detail transform may also be implemented according to BERT. The processing by the document ingestion engine 126 can include natural language pre-processing that determines at least some linguistically based information, such as detection and recording of locations of named entities (e.g., person and company names) in the document, expansion of structured data, such as tables, into searchable form of equivalent text, information conversion into knowledge representations (such as a predefined frame structure), extraction of semantic meaning, etc. In some embodiments, the resultant fine-detail transformed data may be combined with the original content that is being transformed, along with derived or provided metadata (although such metadata is not critical, it can facilitate the performance of intelligent searching and question answering for a document). In some examples, the combination of the transformed content and the source segment can be further augmented with automatic questions that may be germane to the source segment, so that these generated questions are combined with the particular segment (or in a particular location in a full document that includes the entirety of the source content and the corresponding transformed content), or with a particular information field. When processing questions from a user, a similarity between the user's question and such automatically generated questions can be used to answer the user's question by returning the information (e.g., a pointer or actual user-understandable content).

With continued reference to FIG. 1, ingested content produced by the document ingestion engine 126 is stored in document object model (DOM) repository 140. The repository 140 is typically implemented on one or more data storage devices (distributed, or available at a single local location) that can be accessible from multiple access/interfacing points between the repository 140 and other modules/units of the document processing agent 110. In the diagram of FIG. 1, the repository 140 is depicted as having two access points, with one access point being a one-directional link between the ingestion engine 126 and the repository 140 (i.e., a link to allow writing content from the engine 126 into the DOM repository 140) and a bi-directional access point connected to a query processing module 136 that provides query data to the DOM repository 140 (in order to search the DOM records stored in the repository) and to receive search results that are forwarded to the user (optionally after some further processing, possibly including disambiguation processing via an interactive iterative exchange with the user) that submitted the query. In some embodiments, the access point to the repository can be implemented as a single point connected to a module configured to perform the query processing and the document ingestion operations.

The DOM repository 140 is configured to (in conjunction with the document ingestion engine 126 and/or the query processing module 136) store, manage, and search DOM records 142a-n. Content of a DOM record typically depends on the transformation performed by document ingestion engine 126. A DOM record can include data items associated with a particular source document or a source document portion. For example, one DOM record may be a collection of items that includes an original portion of a source document, metadata for that source document portion, contextual information associated with that source document portion, a corresponding coarse vector(s) resulting from a transformation applied to one or more fixed-sized (or substantially fixed-sized) segments of the original portion of the source document (to facilitate a fast-search process), a corresponding resultant fine-detail transformed content resulting from a fine-detail transformed (to facilitate a more accurate and refined textual search), etc. Thus, if the transformation resulted in a vector of values representative of the textual content of a segment, that vector is stored in the repository, possibly in association with metadata (added or embedded into the vector), and/or in association with the original content (in situations where the actual original text-content is preserved; in some embodiments, for security or privacy reasons, the source content may be discarded upon its ingestion, or may be available only at the customer's site). Metadata associated with the transformed content may include contextual information associated with the original source content, and document location information that indicates the location or position of source content that resulted in the transformed content within the larger source document. Such document location information can be provided in the form of pointer information pointing to a memory location (or memory offset location) for the source document stored in the customer network, i.e., so that when the pointer information is returned to a requesting user, it can be used to locate the memory location where the relevant content constituting an answer to the user's query can be found.

The transformed content (which may include several transformed content items, resulting from the various transformations applied to segmented content), metadata, and/or source content stored in the repository 140 together may define a unified record structure, in which each of the transformed content, metadata, and/or original source content is a field or a segment of the unified record structure. Individual records, when they correspond to discrete document segments of a larger source document, can be associated with each other (e.g., by arranging them sequentially or through logical or actual links/pointers) to define larger document portions (e.g., chapters for a particular document), or to define the entire original document that was segmented and ingested.

As further shown in FIG. 1, the document processing agent 110 further includes the query unit (also referred to as a query stack) that is configured to receive inputs (data representative of queries from one or more users authorized to submit queries in relation to at least some of the ingested documents arranged in the DOM repository 140), and in turn provide output data returned to the initiating user. The query stack includes the interactive user query interface with ambiguity resolver 130 (which may be similar to, or implemented using the same hardware and software as the server interface 120) in communication with a query processing module 136 (also referred to as a query engine). As will be discussed in greater detail below, the query processing module may include a transform engine to apply to queries submitted by users similar transformation(s) to generate transformed query data that is compatible with the transformed content in the DOM records 142a-n maintained within the DOM repository 140. The transformed query can include coarse numerical vector type transformed data that can be used to search numerical vector transformed content in the repository 140, fine-detail transformed query (that can be used to search similarly formatted fine-detail transformed content in the repository 140), or any other transformed format that may have been used to ingest the source document. As will further be discussed below (in reference to FIG. 2), the interactive interface with an ambiguity resolver 130 is configured to not only receive and process query data from the user, and provide query output back to the user, but also to determine (on its own or in combination with other modules of the agent 110) disambiguation information. That disambiguation information may include initially-provided (with the query) disambiguation information to help with the initial searching/matching operations (e.g., prefiltering operations) performed on the searchable content managed by the agent 110 (either in the DOM repository 140 or the cache 135). The disambiguation information may also include postfiltering disambiguation information dynamically generated that is presented to the user to solicit the user to provide clarifying information to resolve ambiguity present in two or more of the query results. For example, when two answers are associated with the same or similar concept/category of information (be it an entity name, associated contextual information, or some abstract concept derived using natural language processing or a learning machine implementation) but have different concept/category values, intermediary output may be provided to the user (e.g., as a visual disambiguation prompt, or an audio disambiguation prompt) requesting the user to provide clarification information specifying which of the identified concepts is more relevant to the user's query. The disambiguation information returned by the user is then used to select one or more of the initial matches (and may eliminate some other matches), and/or to rank (based on computed relevance determined using the returned input from the user) the initial or remaining matches.

In embodiments in which the repository 140 includes multiple types of transformed source content, the search of the repository 140 may be implemented as a multi-pronged search. For example, because coarse numerical vector representation is generally more compact and easier to search (but may not as accurate as fine-detail transformed representations, whether achieved by a BERT-based transformation or some other transformation), a first prong of a search to determine an answer to a submitted query may be to convert the query data into coarse vector representation, and to use that first transformed query representation to search records in the repository 140 matching (e.g., according to some closeness criterion that may represent the distance, or difference, between the transformed vector query data and the transformed vector ingested content data) the coarse numerical-based transform of the query data. This type of initial searching may be referred to as fast-search. The results of the search may result in the identification of one or more answer candidates (e.g., identify 1000, or any other number, of possible segments that may contain an answer word sequence responsive to the query submitted by the user). The identified first batch of possible results can then be used to perform the second stage of the search by converting the query to a fine-detail transformed query and searching fine-detail transformed content associated with the search results identified in the first stage of the search process. This searching stage may be referred to as the detailed, or fine-grained, search. It is to be noted that, in some embodiments, the fast search may be used to identify the original portions of source content associated with the identified candidates, and those identified portions may then be transformed into fine-detail transform content. In such embodiments, the repository 140 does not need to maintain fine-detail transformed content, but rather the transformation of source content is done based on which portions have been identified by the fast-search as possibly containing an answer to the query. In alternative examples, searching for answer to a query may be performed directly on the entire fine-detail transformed content records without first identifying possible candidate portions of source content through a fast-search of fast-searched transformed content records.

Thus, in some embodiments, the query stack (e.g., the query processing module 136) is configured to transform the query data into transformed query data compatible with the transformed source content (e.g., compatible with one or more of the transformed content records in the DOM repository 140). For example, the fast-search-compatible transformation may be a coarse BERT-based transformation (e.g., using a learning engine implementing the same or similar trained learning model used to produce the searchable transformed content from the source data) that is applied to the entire query data (e.g., a natural language question) to produce a single vector result. The query processing module may, for example, launch a fast-search process in which it identifies one or more candidate portions in the transformed source content (with respective numerical vectors resulting from the coarse transformation) matching, according to a first criterion, the transformed query data. For example, the matching operation may be based on some closeness or similarity criterion corresponding to some computed distance metric between a computed vector transformed query data and various vector transformed content records in the repository 140. As described herein, in some embodiments, the transformed content may include vectors corresponding to possible questions that users may ask to which the source content provides a possible answer. The fast search may thus, in some embodiments, compare the transformed query result (generally a resultant vector record) to searchable vector records representative of possible questions that could be asked in relation to source content from which those searchable vectors were generated.

The query processing module 136 may be further configured to determine, from one or more fine-detail transformed content records corresponding to the one or more candidate portions identified based on their coarse transformed vectors, at least one fine-detail transformed content record matching, according to a second criterion (e.g., some other closeness or similarity metric, or the same criterion applied with respect to the coarse transformation data), a fine-detail transformed data of the query data. Alternatively, in embodiments in which a fast-search is not performed, the query processing module 136 may be configured to identify one or more candidate portions in the transformed source content with respective fine-detail transformed content records matching, according to a second criterion, the transformed query data.

In some embodiments, the interface 130 and/or the query processing module may be coupled to a query cache 135 and a question generation unit (which may be part of the cache 135 or of the query processing module 136, or may be a separate unit). The query cache 135 stores, among other things, answers/contents corresponding to frequently asked questions. Such answers/contents may include content previously retrieved from the DOM documents (and/or from their corresponding raw source content) in response to previously submitted queries. Counters associated with such cached answers can track the frequency at which specific questions and answers have been submitted and/or retrieved. The cache 135 can also be configured to discard cached content that has not been requested within some reference (threshold) time interval. Content in the answer cache may also have been stored by the administrator (e.g., operating from a station, such as the station 152 via the admin interface 125) in anticipation of some likely questions that users of the customer system (network) 150a were expected to submit, or to override content that may have been retrieved from the DOM repository 140 (e.g., content that, based on subsequent feedback from users, was determined to be inaccurate or unresponsive to the query submitted). Thus, in some embodiments, the query stack is configured to determine whether received query data matches one of pre-determined questions (which may be stored in the answer cache), and to generate the output data based on one or more answer data records (possibly stored within the answer cache) in response to determining that the received query data matches one of the pre-determined questions. In some embodiments, the matching of query data to the past questions and associated answers stored in cache is performed by computing a score that is based on the combination of the questions and their answers, and ranking the computed scores to identify one or more likely matching candidates.

The query processing module may also include a question generation engine that can determine (e.g., based on a trained learning engine and/or using a repository of question data) follow-up or related questions to one or more questions submitted through the query data. Follow-up questions can be generated by paraphrasing the query submitted, e.g., transforming and/or normalizing the submitting query to modify the question submitted using, for example, a trained learning engine. In some embodiments, answer data determined for the submitted query (e.g., based on content retrieved from the DOM repository 140 via the query processing module 136) may be processed (by a separate module) to formulate further questions from the answer. Such derived questions can then be re-submitted to the query processing module to retrieve follow-up answers. This process can be iteratively repeated up to a pre-determined number of times. In some situations, the content stored in the DOM repository 140 may associate multiple questions (represented in whichever transformation format(s) that was applied during the document ingestion stage) with each processed segment of the source document. As noted, generation of transformed content may include, for each processed segment, data representative of questions associated with the processed segment, metadata, and content that may be provided in transformed format and/or the original source content. Thus, upon submission of a query (generally in transformed format computed, for example, according to a coarse-BERT or a fine-BERT type transformation), at least one DOM record/element will be identified. That search result may possibly be associated with multiple questions, including the question that may have resulted in a match between the identified resulted and the submitted query. One or more of the additional questions (i.e., other than the question that was matched to the query) may be used as a separate query to re-submit for searching to identify additional content that may be germane to the original query submitted by the user.

As further shown in FIG. 1, the determination of an answer to a query can be initiated by a user submitting a query 172 via a link 170 established between a station 154a and the interface 130 (as noted with respect to the links established to transfer source documents for ingestion, the links can be based on any type of communication technology or protocol, including wired and wireless communication protocols). The query 172 may be an actual unprocessed question submitted by the user, or may be partially or fully transformed (e.g., for privacy and security reasons). For example, the station 154a may apply a transformation commensurate with the transformation applied by the ingestion engine 126 (in which case, performing a similar transformation at the query stack may become unnecessary). Alternatively or additionally, authentication and encryption processing may be performed on the query 172. The query (question data) 172 is transmitted to the document processing agent 110, and is received at the user query interface 130. Upon receipt of the query, a determination may be made as to whether appropriate answers are available in the cache 135 of pre-determined answers. If there is a pre-determined question-and-answer (e.g., the query data matches one or more pre-determined questions), one or more of the pre-determined answers is used to generate the output data (illustrated as output data 174) that is returned to the user via the link 170 (or through some other link).

Generally, the query data is transformed (if it was not already transformed at the station 154a) by the query stack into transformed query data. The transformed data may provide the query in one or more transform formats that are compatible with the formatting of the transformed source content stored in the DOM repository 140. In some embodiments, the query data may also be used to generate one or more additional questions (e.g., follow-up questions, or questions related to the original query submitted by the user). In situations where an answer to the query is available from an answer cache, that answer itself may be used as a basis for generating further one or more questions that may be related to the cached answer(s). The query or the transformed query is used to search, via the query processing module 136, the DOM repository 140. As noted, the searching may be performed as a multi-pronged process according to multiple transformation formats used to store data in the DOM repository 140.

The output generated in response to a submitted query generally includes a pointer to the source content available at the customer network 150a. Because the data stored in the repository 140 is ingested based on source documents maintained at a document library available at the customer network, to which the user submitting the query has access, and because the source document might not have been stored in their original form at the document processing agent 110 (e.g., for security reasons, in order to protect sensitive data from being compromised), the output that is returned to the user does not require that actual answer data be sent back to the user. Instead, the pointer returned as the output of the query can identify the address or location of the answer with the appropriate document available to the user at the user's network 150. For example, in the illustrated example of FIG. 1, the output data is shown as a pointer to the specific location of the answer in the document 162a (stored in the library 160 along with documents 162b-d). Such a pointer may thus include data representing the document 162a, e.g., a network address or a memory location where the start of the document is located, and a specific location of the portion(s) of the document that represents the answer to the question asked by the user at the station 154a (e.g., a relative offset from the beginning of the starting location of the document 162a, or an actual address or memory location where the starting point of the identified portion(s) is located). The pointer data provided in the output data may have been included in a metadata field of a DOM record that included transformed content data determined (e.g., by the query processing module 136) to match (according to one or more applied matching criteria) the query submitted by the user. In some embodiments, the output data may include, in addition to or instead of the pointer data, at least part of the source content corresponding to the at least one portion of the transformed content and/or a summary of the source content corresponding to the at least one portion of the transformed content.

### Disambiguation Information for Processing Multi-Answer Search Results

As discussed with respect to FIG. 1, a query is submitted to the document processing agent 110 (e.g., via the interface 130), in response to which the document processing agent 110 will return a set of matches. Generally, the returned matches satisfy one or more relevance or matching criteria, but nevertheless the set of matches may include multiple answers which have been determined to be responsive to the query, e.g., because the query was not specific enough, and consequently multiple answers, from the content stored in the DOM repository 140, were found to satisfy one or more matching criteria applied during the search of the DOM repository 140. For example, the query “how do I install a browser?” searched in technical electronic documentation of a company that uses multiple different computing systems may find tens of different answers relating to different browsers that can be installed on different available computing platforms and operating systems used by that company. Thus, the query yields multiple answers (e.g., answers relating to installing Chrome™ browser on different computing systems such as a Mac™ system or a Windows™-based system, answers relating to installing Explorer™ on different computing systems, etc.) that are directed to substantially the same concept (namely, the concept of installing a browser) and have different possible legitimate answers (i.e., different values associated with substantially the same concept). Similarly, the answer to a query such as “what is the life of the battery of my laptop?” depends on the laptop brand, model, and other technical details that have not been specified, and consequently map to multiple possible answers that provide information about battery life for different types of computers. The resultant multiple answers for a query create ambiguity in terms of what the user submitting the query is searching for, which requires more specificity and disambiguation to resolve.

Accordingly, the solutions and approaches described herein address the problem of answering questions from large unstructured data. Every question has the potential to return many valid answers, and therefore additional information is required in order to disambiguate the question and select from the valid set one or more answers (and/or to rank the answers). This additional information can be collected through an interactive dialog with the user. There are several parts to the proposed solutions, including:
1) Determining what information is required in order to disambiguate between different valid answers to the same question;
2) Associating that information to the appropriate locations in the content where the answers appear;
3) When a question is asked, determining what contextual information is required in order to disambiguate among the different answers to that question;
4) Determining how to solicit the information interactively from the user;
5) Selecting the relevant answers based on the contextual information provided.

In some embodiments, chatbot technology can address the issue of disambiguation by providing tools to design dialogs, so that clarification questions are designed into the flow of the dialog. Depending on the answer to one question, the user might be asked another question or be provided the answer when all the contextual information has been collected. This approach relies on correctly classifying the intent of the question, which requires building a model based on example questions, designing the prompts to elicit the required entities, and authoring the answer. The solution proposed herein automate many of the operations to obtain disambiguation information.

Thus, with reference to FIG. 2, a flow diagram 200 for a framework to determine disambiguation information for use during execution of query (question-answering) procedures, is shown. The flow diagram 200 illustrates operations in a computing framework similar to that illustrated in relation to FIG. 1. However, similar disambiguation information determination processes may be performed on other computing frameworks and configurations. The flow diagram 200 includes several parts corresponding to separate functionalities and stages of the proposed framework. A first processing stage/section, depicted inside the box 210, includes processing configured to add structure to unstructured content. The processing associated with the box 210 may be implemented based on implementation similar to that of the document processing agent 110 of FIG. 1. In block 212, a customer (e.g., an entity or organization) provides the information (including unstructured information such as documents that are to be processed and converted to searchable documents), and structured information. For example, in the block 212 a communication link is established between an administrator station (such as the station 152) and a processing agent (such as the processing agent 110 of FIG. 1). An administrator, interacting via an administrator station, can provide the document processing agent (via an admin interface, such as the interface 125 of FIG. 1, implementing connectivity with remote or local computing systems) with information identifying location of the source document in a repository (such as the document library 160 of FIG. 1) maintaining the plurality of source documents, control configuration and operation of the functionality of the document processing agent 110 in relation to the customer's network. The information regarding the documents to be processed may be in the form of a network address, and access information, to access the repository of documents. Alternatively, the information can include actual content (raw, or transformed in some form). Communication between the administrator station and the admin interface 125 can be established based on any communication technology or protocol, and may include authentication and/or encryption data. For example, the administrator station can send a message providing the document processing agent 110 with a network address for the document library 160 (and/or identity of documents within that library that the agent 110 is to access and process).

The customer-provided information can also be provided for other content sources, whether within the customer network 150a, or elsewhere, including: a) data stored in collaboration systems such as Slack, MS Teams, MS productivity Suite (Office 360), Google G-Suite and alike (traditional e-mail servers, storing e-mail communication between specified senders and recipients may also be processed to capture relevant data), b) data stored inside enterprise SaaS applications such as SalesForce, ServiceNow, etc., c) data inside web pages of different websites and different web applications, be they customer-facing web applications, employee-facing web applications, etc.

Once the customer provided information is received, ingestion processing is performed at a block 214 on the received data (e.g., source documents) using, for example, a system similar to the document ingestion engine 126 of FIG. 1. As discussed, ingestion processing can include pre-processing (including segmentation and context information identification) applied to the source documents, followed by transformation of the pre-processed documents into searchable (e.g., Q-A searchable) content. Ingested content produced by the block 214 is subsequently stored as part of a library of DOM (document object model) objects, illustrated as KD (knowledge distillation) repository 216. The customer provided information received in block 212 may also be used to generate index tables for the information (at block 218). The index table can include one or more identifiable concepts or entities (persons, places, or other nameable concepts) to later aid entity/concept-based queries, as well as arrangement and ranking of subsequently determined search result (responsive to future queries). The index table data may be derived using a learning machine, or alternatively (or additionally) using natural language processes (implemented either at the block 218 or at Natural Language Understanding block 222). The natural language processes may use ontologies to recognize and derive semantic and syntactic information from the input data (e.g., in this case, the user provided information). Thus, in some embodiments, at least some of the concept identification processing may be performed during ingestion time. That is, the determination of concepts relevant to ingested content segments is done in advance of submission of any query, and is generally performed for most or all of the ingested content segments. Alternatively, determination of concepts associated with ingested content segments may be done after a search is conducted to produce the N best results. For example, the abstraction of concepts that were identified based only on closeness/proximity criteria between, for example, a query vector representation and vector representation of content segments, and/or closeness between semantic meaning of the query and semantic meaning associated with ingested content segments.

The ingestion process at the block 214 may include various pre-processing operations performed on the content, e.g., to divide the source documents into segments of a manageable size, while preserving as much germane contextual information. Thus, the document ingestion engine is configured to receive a source document, apply one or more pre-processes to the source document to produce contextual information representative of the structure and content of the source document, and transform the source document, based on the contextual information, to generate a question-and-answer searchable document.

Ingestion of documents can be based on the specific source of data and/or on the desired or intended presentation of information (e.g., presentation of response data returned in reply to query data submitted by a user). For example, where the source of data (the content) is from some specialized application (Salesforce, Slack, etc.), the ingestion of the source content may be configured to perform specialized or dedicated pre-processing required for the specific source, e.g., convert chat data, or data arranged in specialized format records, such as records of Salesforce, into prose, or some other format more conducive to the transformations applied to segmented portions of the source content.

In some embodiments, document ingestion may be based on (or may take into account) the particular way the response data is to be presented. Consider the following three examples of ways to achieve the data presentation. In a first example approach, data is presented according to an API-based methodology, where, for example, the answer/paragraph is included in addition to the location (such as page number or begin/end positions of the answer snippet) provided to a renderer of different format types (such as HTML, PDF, Word doc., etc.). The renderer can be implemented as a macro or plug-in/extension that allows for locating the answer snippet and paragraph in the document, and performing special processing of rendered segments e.g., by bolding or highlighting portions of the data, etc. of the segments. Another example approach for presenting response to data is to preserve, during the document processing phase (e.g., via the ingestion engines), screen shots of segments in the documents that are candidates for presentation (e.g., effectively, pre-rendering the output content). During a subsequent presentation of data identified as being responsive to a query, a client application can pick the most appropriate screenshot that holds the snippet/paragraph. In a third approach to present query results, after the appropriate segmentation for presentation is created, every segment of the processed documents, which may be available in different formats (e.g., as a Word doc, html, etc.), is converted to a PDF document format that includes the segment (with appropriate connections to the retrieval segments, where one-to-one mapping between segments are achieved and begin/end position of the answer snippet are passed through the API to a common PDF renderer) that allows for locating and highlighting the answer snippet.

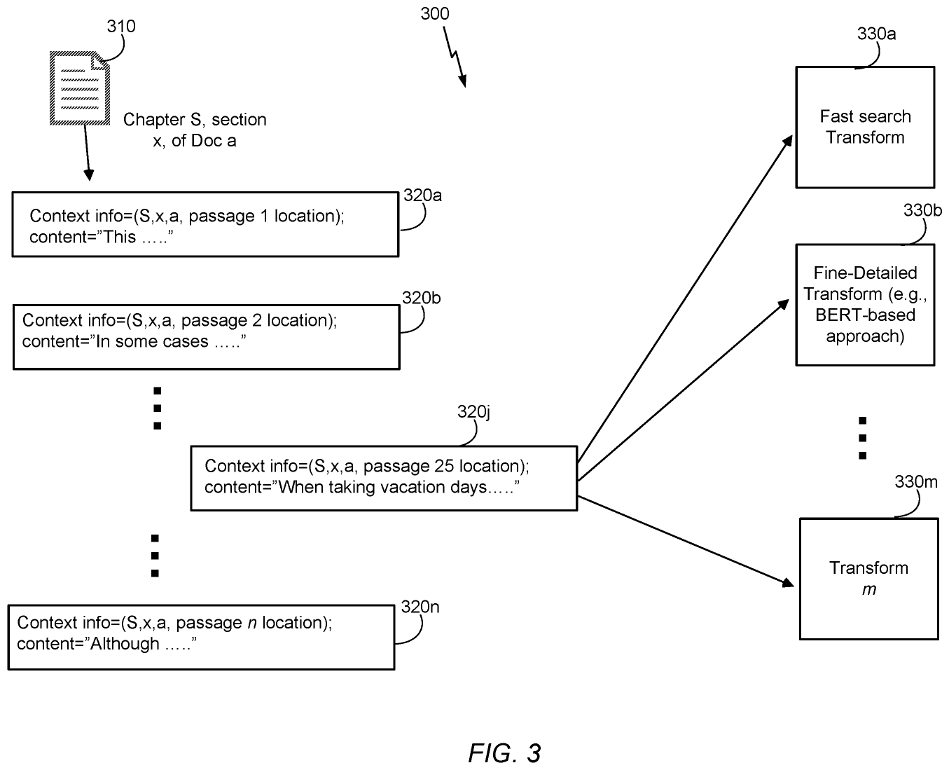

One example of a pre-processing procedure is the segmentation of source content for a source document into multiple document segments. Such segmentation can be performed according to hierarchical rules semantically associating one portion of the source document with one or more other portions of the source content. For example, a sliding window of a fixed or variable size (e.g., 200 words) can be applied to the source content to generate manageable-sized segments on which to apply content transforms. However, when segmented into small chunks, the content segments may lose important contextual information that otherwise would have been available for a larger size segment. For example, a passage in the middle of a section of a document may, in isolation, not include important contextual information such as the section heading, location of the passage relative to earlier passages in the section, font sizes associated with other passages not captured by a particular segment (e.g., when the present passage is a footnote), etc. Therefore, in some embodiments, contextual information (e.g., section heading, chapter heading, document title, location, font type and size, etc.) may be combined with one or more of the document segments. This pre-processing procedure is illustrated in FIG. 3, providing a diagram of an example document ingestion procedure 300 with pre-processing to extract contextual information. In FIG. 3, a source content 310 (which may be part of a source document) has been segmented into segments 320a-n. Each segment has its own individual segmented content (resulting from applying a segmenting window to the source content), that is combined with contextual information (which may be text information, numerical information, or both) associated with each segment. As can be seen, at least some of the contextual information, namely the document identity (“Doc a”), the Chapter information (Chapter S), and the heading information (section x) is common to the segments illustrated in FIG. 3. This allows the transformation that are subsequently applied to the segment to preserve at least some of the contextual information, and thus preserve some of the relevance of the segment being transformed to the subject matter.

In some examples, to simplify the segmentation process (so as to facilitate more efficient searching and retrieval), the source documents may be segmented to create overlap between the sequential document segment (not including the contextual information that is separately added to each segment). Thus, for example, in situations where a segment is created by a window of some particular size (constant or variable), the window may be shifted from one position to the following position by some pre-determined fraction of the window size (e.g., ¾, which for a 200-word window would be 150 words). As a result of the fractional shifting, transformations (e.g., vectorization of BERT-based transformations) applied to overlapped segments results in some correlation between the segments, which can preserve relevancy between consecutive segments for subsequent Q-A searching. In some embodiments, heading information (and other contextual information) may be added directly to partitioned segments. Alternatively, heading and contextual information may either be transformed into vectors that are then added to the vectors resulting from transformation operations applied to the content extracted by the sliding window, or may be combined with the content extracted by the window before the transformation is applied to the resultant combined data. By associating neighboring segments with each other (e.g., through fractional shifting of the window over a document to form the segments), identification of relevant paragraphs (responsive to submitted queries), for the retrieval and presentation processing for top paragraphs and associated answer snippets, is improved.

Another pre-process that can be applied during segmentation of the source document relates to the handling of table information (i.e., when the original content is arranged in a table or grid). This pre-processing is used to expand structured data arranged in tables (or other types of data structures) into searchable form such as equivalent text. For example, upon identifying a portion of the source document as being a multi-cell table, substitute portions are generated to replace the multi-cell table, with each of the multiple substitute portions including a respective sub-portion content data and contextual information associated with the multi-cell table. Additional examples of pre-processes include a procedure for associating contextual information with one or more portions of the source document based on, for example, a) information provided by a user in response to one or more questions relating to the source document that are presented to the user, and/or b) based on one or more ground truth samples of question-and-answer pairs.

In some examples, contextual information might not be explicitly included with a segment, but instead may need to be discovered, and included with document segments as augmented information (in this case, augmented contextual information). For example, entity discovery (determining identity of relevant entities referenced in the document) can be used to help speed up the search (fast-match (FM) searching, or detailed match (DM) searching) during inferencing, and to improve searching accuracy and generate an improved schema.

Consider the following example implementations:
Each search unit (e.g., 200-word windows, paragraphs, documents, etc.) is analyzed with respect to the inherent entities associated with the search unit, and also analyzed with respect to metadata associated with entities for a particular task (e.g., HR, author, organization etc.)
Each search unit is tagged with the appropriate inherent and metadata entities.
During the search, different heuristics can be used which could eliminate many of these search units by identifying them as irrelevant to the query at hand. For example, in one use case, where the user's question is determined with a high degree of confidence to relate to some specific subject matter (e.g., because the user explicit identification of the subject matter, e.g., a question stating “I have a financial question,” or because the subject matter can be inferred, through rules or classification engines, to pertain to the particular subject matter), all documents/document objects for other subject matters (HR, security, etc.) can be eliminated from further consideration, and those documents do not need to be searched in response to the submitted query.
The by-product of such filtering is to speed up the FM and DM searching. Additionally, potential answer units from irrelevant categories do not create mis-recognition errors, and consequently this helps to improve the accuracy of searches.

Information about a specific entity (or entities) relevant to a user's search can also be used to generate more accurate additional questions (e.g., to determine different ways to paraphrase the input query so that additional possible question-answer pairs can be generated), and also to provide additional context that can be used to search the repository of data (be it DOM objects in transformed form, or user-readable data formatting).

As will be discussed in greater detail below, during submission of queries to identify relevant matches from the ingested content database (e.g., the DOM library/repository 140 of FIG. 1), contextual information may be obtained (automatically or through direct input by the user) to improve the quality of the returned matches. For example, entity contextual information may also include information about specific items (e.g., different product brands) and elements that provide additional contextual information to refine the search and improve output results.

In some embodiments, document processing (e.g., segmentation) can be performed as two separate tasks. In one processing task, the source document is properly segmented and organized into small chunks, e.g., paragraphs, with additional augmentations (e.g., the vector sequence that represents the heading of a section can be appended to the vectors of every paragraph in that section). These augmentations are used to improve the retrieval accuracy. In a parallel task, a document is segmented in the most appropriate way for presentation purposes. The two different resultant segmentation outputs need to be associated with each other such that when, during retrieval processing, the top paragraphs and associated answer snippets are identified, but what is presented to the user are the presentation contents (rather than the identified answer snippets) associated with the identified answer snippets. In other words, the system can ingest a particular passage to facilitate searching operations, and separately ingest that particular passage to facilitate presentation operations. In this example, upon identifying the passage as a result of matching a query to the searchable ingested content, the presentation content associated with the identified passage is outputted.

Having segmented a source document into multiple segments, each segment may be provided to one or more content transforms (or transformers) 330a-m that transform the segment (content, and optionally the contextual information, although in some embodiments the contextual information may be preserved without transforming it) into a resultant transformed content that is associated with question(s) and answer(s) related to the original content of the respective segments. In the example of FIG. 3, m transforms are shown, each being applied to any one of the segments (such as the segment 320j). Although the same segment, for example 320j, is shown as being provided to each of the transforms, in some embodiments, different segmentations procedures may be applied to obtain segments of different sizes and configurations as may be required by each of the individual transforms (e.g., the coarse fast-search transform 330a may be configured to be applied to a segment of a first segment size, while the fine-detail transform 330b may be configured to be applied to a segment of a second, different size (e.g., strings of several words)).

As noted above, an example of transforms that may be applied is the fast search (also referred to as a fast-match, or a coarse search) transform that is based on transforming fixed-sized (and typically large) segments of input data into vectors (the vectors too may be, but do not necessarily have to be, of uniform dimensions). The resultant transformed vectors can be representative of possible questions and answers that are associated with the input segment that was transformed. The resultant vectors generally provide a starting point to narrow the number of possible document objects that need to be searched more thoroughly (e.g., using content transformed according to another, more fine-grained, transforms). For example, upon searching the transformed content repository (e.g., the DOM repository 140) based on a match between the fast-search transform results and query data converted into a representation compatible with the fast-search transformed content, the resultant search can result in, for example, 1000 potential candidates (or any other number of candidates). More refined content matching can then be performed on transformed content objects that correspond to the candidates identified by searching the fast-search transform content. The fast-search (coarse) transformation may be implemented according to the BERT-approach. Another transform, illustrated as being performed by transform unit/module 330b in FIG. 3, is the fine-detail transform, which in the example of FIG. 3 is also based on a Bidirectional Encoder Representations from Transformers (BERT) approach.

Under the BERT approach, when a query is received, the relevant sequences in the documents can be identified quickly (possibly from a set of objects that may have been earlier identified using, for example fast-search processing) by identifying a part of a document (e.g., a paragraph) that may contain the answer, and identifying the span of words in that part of the document that contains the specific answer. In some examples, under the BERT approach the question and the answer are concatenated (tokenized for example using WordPiece embeddings, with suitable markers separating the question and the answer) and processed together in a self-attention-based network. The output of the network indicates a score for each possible starting position for the answer and a score for each possible ending position for the answer, with the overall score for a span of the answer being the sum of the corresponding start and end positions of the answer. That is, a self-attention method is used where embedded vectors of a paragraph and a query are mixed together through many layers followed by a decision-maker layer and segmenter logic to provide an efficient method to determine if a question is answerable by a paragraph, and if so, determine where exactly the span of the answer lies in the paragraph.

In the BERT-based approach, a network may first be trained on a masked language model task in which a word is omitted from the input, and predicted by the network by an output layer that provides a probability distribution over words of the vocabulary. Having trained the network on the masked language model task, the output layer is removed, and in the case of the question answering task, a layer is added to yield the start, end, and confidence outputs, and the network is further trained (e.g., fine-tuned, transfer learning) on supervised training data for the target domain (e.g., using Stanford Question Answering Dataset, or SQuAD). Having trained the network for question answering for the target domain, further training may be used to adapt the network to a new domain. Another training strategy used for BERT is the next-sentence prediction, in which the learning engine is trained to determine which of two input segments (e.g., such segments may be neighboring sentences of a text-source) is the first of the two segments. When training the model, both the masked-language and next-sentence training procedures may be combined by using an optimization procedure that seeks to minimize a combined loss function. Alternatively, or additionally, other training strategies (to achieve context recognition/understanding) may be used separately, or in conjunction with, one of the aforementioned training strategies for BERT.

In example embodiments based on the BERT approach, an implementation, referred to as a Two-Leg BERT approach, may be used in which much of the processing of a query is separated from the processing of parts of a document (e.g., paragraphs) in which answers to the query may be found. Generally, in the two-leg-BERT approach, the neural network architecture has two “legs”, with one leg for processing the query, and one for processing the paragraph, and the outputs of the two legs are sequences of embeddings/encodings of the words of the query and the words of the paragraph. These sequences are passed to a question-answering network. A particular way this approach is used is to precompute the BERT embedding sequences for paragraphs, and complete the question-answering computation when the query is available. Advantageously, because much of the processing of the paragraphs is performed before a query is received, a response to a query may be computed with less delay as compared to using a network in which the query and each paragraph are concatenated in turn and processed together. The paragraphs are generally much longer than the queries (e.g., 200-300 words versus 6-10 words) and therefore the pre-processing is particularly effective. When successive queries are applied against the same paragraph, the overall amount of computation may be reduced because the output of the paragraph leg may be reused for each query. The low latency and reduced total computation can also be advantageous in a server-based solution. As noted, in the implementations described herein, the BERT-based processing of the source documents produces transformed content that is typically stored in a repository (such as the DOM repository 140 of FIG. 1). The underlying documents from which the BERT-based transformed content is generated may be retained as well, and associated with the resultant transformed content (as well as associated with corresponding transformed content obtained via other transforms).

In some embodiments, the BERT-based transformers (e.g., used for the fast, coarse, transformation, and/or for the fine-detail transformation) may be implemented according to encoder-based configuration. For example, a BERT-based transformer structure may include multiple stacked encoder cells, with the input encoder cell receiving and processing the entirety of an input sequence (e.g., a sentence). By processing the entirety of an input sentence, a BERT-based implementation can process and learn contextual relations between individual portions (e.g., words in the input sequence). An encoder layer may be realized with a one or more self-attention heads (e.g., configured to determine relationships between different portions, e.g., words in a sentence, of the input data), followed by a feedforward network. The outputs of different layers in an encoder implementation may be directed to normalization layers to properly configured resultant output for further processing by subsequent layers.

It is to be noted that, in some embodiments, the fast-search vector transformation (transforming a segment into a compact-sized numerical vector) may be applied to a tokenized version of the text (e.g., some transformation, such as transformations achieved through the BERT process, may have already been performed to produce an intermediary (e.g., tokenized) content, to which the fast-search transform is then applied).

The transform modules (fast-search, BERT-based, or any other type of transform) may be implemented through neural networks that have been pre-trained to produce transformed content associated with question-answer pairs. Other transform implementations may be realized using filters and algorithmic transforms. Training of neural network implementations may be achieved with a large training samples of question-answer ground truths that may be publicly available, or may have been internally/privately developed by the customer using the system 100 to manage its document library.

Turning back to FIG. 2, in some embodiments, the part 1 processing 210 may be configured to determine (e.g., using the ingestion process block 214) the dimensions of ambiguity in the data (this may be performed as part of the document ingestions operations realized, for example, by an ingestion engine similar to the document ingestion engine 126). The dimensions can be in the form of categories with multiple values. These dimensions can come from knowledge workers or can be learned (e.g., using a learning machine implementation) from analyzing the data using one or more ontologies of concepts. For example, source content for a segment, in combination with associated metadata (e.g., metadata such as document titles, section headings, etc., that provide contextual information about the relevance of an analyzed segment to a particular concept). An ontology of concepts can be as specific or as coarse as desired, depending on the desired implementation and availability of training data and ontologies. For example, in the example discussed above in a query of “how do I install a browser?” is submitted, an ingestion-time (or alternatively a query-time) analysis may identify browser as a previously learned concept (represented parametrically or textually) that can be searched within the repository of searchable content (in a DOM repository or some other database or repository of searchable content). Such dimensions, also referred to as concepts, can be formulated as a set of category/value tuples. Concept-related contextual information (in the form of metadata) attach metadata to the content, indicating where a passage is specific to a category/value pair. Two passages in the content that are identified as possible answers to a query are ambiguous along a particular dimension if they have metadata with the same category and different values. The content can be annotated using techniques such as extracting entities from the text in paragraphs or headings; collecting information from the title, location and other data about a file; or collecting tags that have been added by content owners or others annotating the data. The concept identification analysis may also assign a value to that concept representative of the relevance and the association between the identified concept and the segment being analyzed. For example, the source content segment may be associated with a heading or a document title indication that the document relates to Windows™-based computing devices. The concept of “browser” may then be assigned, for the particular segment being analyzed, a value indicative that the “browser” concept is related to a Windows™-based computing device.

A second part of the framework depicted in FIG. 2 includes the submission of a query, by a user, and an analysis of results of the unstructured search. In the second part (Part 2), standard search techniques can be performed that then return a valid set of answers to a question based on application of one or more matching criteria to the query, or a representation thereof (e.g., an ingested representation based on a similar transformation of source query content as that applied to the source documents), and the searchable content managed by the system 200. In this part of the processes of FIG. 2, the metadata associated with the identified/matched answers are collected, and the answers are returned along with a set of categories/concepts and the values found for each. As noted, concepts/categories may have been derived during ingestion time, or during query-time. Categories that have answers with different values are ambiguous along the dimension of the category. It should be noted that the categories/concepts may have been computed either during the ingestion process (as described above) or may be computed after retrieval of the set of possible valid answer (i.e., the computation of categories (concepts) and values tuples may be performed at search-time (and may be performed in a manner similar to that described above). Determination of concepts associated with answer matches during search time has the advantage of needing to determine concepts only for a limited set of answers (i.e., the N best answers) instead of having to determine concepts for every ingested content segment, thus providing a computational efficiency (with respect to the computation effort that would otherwise have been needed were abstracted concepts were to be derived for all content segments being ingested).

As illustrated, a user provides, via a user interface 230 query input in the form of a question, or alternatively as a more structured search query (e.g., by specifying search terms/values for specific fields). The user interface 230 may include a user-side interface with which the user directly interacts (e.g., a graphic interface implemented as an API or as a browser-based implementation, a voice-based interface, etc.) in communication with a server-side interface (e.g., in implementations where a central document agent serving multiple clients is used) such as the interface 130 depicted in FIG. 1 of a user input running on the user's device, in communication with a communication module to receive and process input from a user). The query data (represented by block 220) may optionally be processed, for example at the natural language understanding block 222, to extract entity information, including to determine entity information/concepts relevant to the query data (e.g., according to similar ontologies used to perform NLP on the customer provided information delivered at block 212), based on which the searching operations performed for the query data are performed. For example, the entity information, and possibly concepts determined for the query, can be used to conduct the search to identify answers that match (according to one or more pre-determined matching criteria) the content of the query (e.g., based on vector representations of thee query and ingested content segments) and/or determined concepts and metadata for the query and the ingested content segments. Entity information and determined concepts may also be used to determine extent or level of a match, according to of the matching criteria used, between the query data and the searchable content). Extracted entity information, including relevant concepts/categories derived from the query data, as well as other contextual data associated with the query or user (including location information, personal and device information associated with the query submitted or the user, etc.) are collected and included with dialog context data, represented by a dialog context block 224. The dialog context block can be dynamically updated as more contextual information becomes available during execution of the query, and as search results are iteratively refined.

The query data is subsequently transformed into processed query data (represented by block 226) compatible with the transformed source content (e.g., compatible with one or more of the transformed content records in the KD 216 repository). The processed query data thus includes resultant transformed vectors, and may also include discovered index types and values (derived based on the NLP operations performed in the block 222, and based on other discovery processes performed to determine relevant concepts and other contextual data associated with query data).

The processed query data is then used to search the repository of searchable content, e.g., according to content searching/matching processing similar to those performed by the query processing module 136. For example, and as illustrated by QA matching block 240, the searchable content is compared to the query vectors (the query data may have been transformed into multiple vectors, for example, one for the fast (coarse) search, one for the detailed search, etc.) to identify content vectors, resulting from the ingestion processing performed on the source content (e.g., the pre-processing and BERT-based transformations), that correspond to passages/excerpts of the source documents. In searching the searchable content for the source documents, the QA matching block 240 may apply one or more matching criteria to identify valid search results. For example, the distance between a query vector and a searchable content vector may be required to be sufficiently close (i.e., the vector distance needs to be below some threshold). Other matching or closeness criteria between transformed vectors (for the query and for the content) may be used. Other matching criteria that may be required to be satisfied when identifying valid search results may include criteria in which some proximity between contextual query data and contextual information associated with identified content records is required. For example, in addition to a vector closeness criterion between the query vector and the content vector being satisfied, the matching processes may also require that the query and content record share the same, or similar, entity information (or concept/category identifier). Additional matching criteria may further be required.

Following performance of the search/matching process by the block 240, the N best matches are identified and provided as intermediate result output 242. The search results may include the vector or parametric values (associated with the identified/matched records), the source content passages/segments associates with the vectors/parametric representation resulting from the transforms applied to the segmented content, contextual information (including entity identifiers, concepts/categories determined for the associated content), etc. As noted, the identification of multiple valid result records (i.e., for situations where N>1) may be indicative that there is ambiguity in the results of the search, possibly because the search was not specific enough, yielding, as a result, multiple legitimate answers. The search result output 242 may be processed (to filter it, e.g., through the disambiguation processing described herein, and/or based on other techniques) to produce a filtered set of answers (depicted schematically as block 244), which may then be provided as output to the user.

Determination of ambiguity in the identified matches is performed by a query ambiguity detector 250. In some embodiments, determining whether two or more of the results/answers produced in response to the query may be performed by identifying one or more concepts (e.g., by a learning machines, implemented by the processing stage 210, applying concept ontologies to source content being analyzed, and/or by natural language understanding block 222 of the framework 200) associated with those two or more results/answers, and determining that at least one of the one or more identified concepts is associated with different respective values for at least some of the multiple matches. In the example of the query “how do I install a browser?”, two possible answers, each associated with the concept of “installing a browser,” may have different values for that identified concept, with those different values corresponding, for example, to an answer pertaining to a Mac™-based computing system, and an answer pertaining to a Windows™-based system. In some embodiments, the existence of multiple answers may not necessarily be deemed to create ambiguity. For example, the framework of FIG. 2 may be configured to detect an ambiguity condition only if the number of matches exceeds a certain answer threshold value. On the other hand, if the search returns fewer matches than the answer threshold number, the user may be allowed to consider all the found matches.

Some of the multiple matches may be associated with different concepts/categories, in which case there would not necessarily be ambiguity between those multiple matches (e.g., because there would not necessarily be a common dimension shared by some of the matches, with such matches having different (conflicting) values for the shared concept). In those circumstances, the framework 200 may provide the user with some or all of the matches, or try to eliminate some of the answers by obtaining disambiguation information from the user to determine the particular concept the user is interested in (e.g., by presenting to the user visual prompts relating to at least some of multiple concepts determined for the matches).

During the disambiguation processing, following the elimination of some of the matches, the remaining answers in the refined (disambiguated) set of matches may be further disambiguated by identifying another (secondary) concept that some of the remaining answers share, and which are associated with different (i.e., conflicting) concept values for that other identified concept. For example, in the case of the “how do I install a browser?” query, the first disambiguation iteration may eliminate Mac™-based computing devices, but would still leave a large number of possible answers relating to Windows™-based browser installation. Under the approach described herein, a second concept (e.g., operating system version number) may be identified for the remaining answers, and the user would be prompted with another request to specify the version number of the operating system on which the browser is to be installed.

In some embodiments, multiple disambiguation concepts may be identified for a particular set of matches, and the user is then be prompted to provide clarification information for all (or some) of the identified concepts. For example, in the initial disambiguation iteration, a user may be asked (in order to disambiguate the browser installation query) to provide the operating system, version number, and hardware information for the user's device. When a user is prompted to provide responses to multiple disambiguation concepts, the user does not necessarily need to provide responses for all the prompted concepts, but instead may provide response data for fewer than the prompted concepts. Any response data provided by the user can be perform some level of disambiguation to thus reduce some of the information entropy for the set of matches (e.g., to eliminate one or more matches deemed to not be relevant in view of the user's response data). The user may also decide to forgo any disambiguation processing, and simply be provided with all the returned matches.

Obtaining disambiguation information (e.g., by the query ambiguity detector 250, or by some other component/process of the framework 200) can be accomplished through several ways. In some embodiments, the disambiguation information may be based on available contextual information. Such contextual information may include information that is associated with recent query transactions, including contextual information regarding recent queries submitted by the user submitting the current transaction. For example, if the user has previously submitted a query seeking technical information about a Windows™-based system, the framework 200 may consequently weigh more heavily (when selecting or ranking the answers resulted from the current query) those answers which are related to Windows-based system (e.g., weighing more heavily answers related to the installing a browser on a Windows™-base system, responsive to the query “how do I install a browser”).

Other immediately available contextual information (i.e., not requiring soliciting further information from the user) may include any other information that is captured at the time the user has submitted the query, including location information for the user, and information indicative of what the user is considering (e.g., what the user is currently viewing), based on which contextual inferences can be made to select one or more of the generated multiple answers. Another example of location-related contextual information that can be used to disambiguate matches (during the matching process for the query or after the query results are identified) is the use of map-based information. In some embodiments, an interactive map rendering (of a geographical area) may be provided alongside, or separately from the visual disambiguation interface (that presents prompts to solicit the user's responses to identified concepts). The map may be rendered in response to a determination that one of the disambiguation dimensions of the matches is one of location (e.g., the results include location-based entity data, or the concept identification processing determines that a concept relevant to the results is one of location). Alternatively, the map may be displayed in response to a specific user selection to include a map rendering with the interactive interface used for submitting queries and disambiguating results. The user can then use the map to zoom in or out, or to select a specific location on the map, to thus indicate the location values that are relevant to the geographical or location dimensionality of the returned matches. Based on the selection facilitated through the map rendering, the framework 200 (and more particularly the interaction process block 252 of FIG. 2) can select one or more of the matches whose location dimensionality values are close (based on the application of a closeness or proximity criterion) to location values indicated by the user's selection on the map visual. For example, in response to a selection on the map of the New York City area, matches with contextual/entity values, or with location-related concepts values, that are within some pre-determined radius from the New York City area will be selected (and possibly ranked according to the closeness of those locations values to the value indicated by the user's selection).

In another example of incorporating available contextual information into disambiguation processing, consider a situation in which a user is interacting with an augmented reality system equipped with cameras (and/or other types of sensors). In such a system, one or more of the cameras will be pointing at location that the user is looking at. Information in the scene captured by the sensor device (e.g., image data, which can be processed by, for example, a learning machine to identify objects and items appearing in the scene) can be used to provide contextual information to a query concomitantly initiated by the user. For instance, if the user looks down (and a camera of the augmented reality system similarly follows the direction and orientation of the user's head to point at the scene being viewed by the user), sees a MagSafe charger (for wireless charging) for his/her phone, and asks “how do I charge my phone?,” a Q-A system (e.g., based on the implementations described herein) will identify different answers for this questions (resulting from a search of the DOM repository) than would be identified if the user were looking down and seeing a car. In this case, the sensor of the augmented reality system is used to determine (or discover) contextual information (e.g., proximity of the user to a MagSafe charger vs. proximity to a car) that can be used to filter already generated answers, or even to limit the search (performed at block 240) just to the determined context.

In some embodiments, the orientation, positioning, and/or location (as may be determined based on positioning techniques using satellite or ground-based signal analysis) of the sensor device (the camera, in this case) can itself provide important contextual information that is germane for selecting answers from the set of matches, or to for searching the repository data, or for providing feedback responsive to disambiguation prompts. For Example, pointing the camera in a downward direction can imply that the information being sought via a query relates to objects that are situated close to the ground. In another example, location of the sensor device can be used to limit the search to answers that have relevance to the particular geographic location of the sensor device (e.g., to determine details related to a specific conference room where the user is located). Thus, a query such as “how do I turn on the video conference camera?” can be modified (or be restricted) to search answers (e.g., from relevant manuals or other source documents stored by the company) for the video camera(s) located within the particular conference room where the user posing the query is located.

Another example where augmented reality systems (or other types of systems equipped with sensors) can be used in conjunction with the document processing (e.g., Q-A type processing) implementations described herein involves situations where factory workers, who may be fitted with streaming bodycams (or hard-hat-cams), can pose queries questions that are modified by contextual information extracted from the captured video stream. A user may, in one situation, ask information about functionality or operation of a “machine,” or information about a certain “product.” The captured image or video by the device carried by the user can identify the particular brand or model of the machine, and, when the user is asking for some specific information about the operation of the machine, the specific model identified through the augmented reality sensor can be used to restrict the search to documents (e.g., user manuals) relevant to the specific machine model identified. Thus, streaming by a camera when used in an augmented reality system adapted to assist factory workers can be used to modify queries (e.g., seeking information about “a machine”) to account for the specific machinery identified according to the video streams generated by a camera (used in conjunction with a learning machine to identify objects and items in the scenery). In another example related to the factory-worker (or technician) scenario, a user may pose a query (e.g., through a voice-based interface, such as an AI assistant app operating on a mobile device carried by the user) asking about the connectivity of a wiring harness. The query may be modified (or restricted) to search answers that may be specific to a wiring harness appearing in a captured image (or video) of the scene, from which the specific model or type of the harness can be identified.

Yet another example where captured image-based data can be used in the course of contextual discovery or to perform disambiguation is when the scenery includes recognizable codes (such as QR codes, barcodes, etc.) that can be decoded to extract meaningful contextual information therefrom. For example, in the above wiring harness example, the wiring harness may include a label with a QR code or a barcode that can be automatically decoded upon being captured by the image-capture device carried by the user. Queries then posed by the user in relation to the wiring harness will be modified (or restricted in some way) so that the answer(s) obtained are relevant to the QR or barcode identified during the context discovery.

It is to be noted that some of the example systems (e.g., augmented reality systems) described herein can be implemented using augment reality goggles (glasses), while other systems can be implemented using cameras installed on smartphone that the user moves to point the camera in the direction of the relevant scenery. Some embodiments of such phone-based augmented reality system may also include an Artificial Intelligence (AI) assistant app (e.g., Siri, Alexa, Cortana, etc.) through which the user may provide his/her queries that are modified based on contextual information determined from the augmented reality system. It is also to be noted that other types of mix-mode input sources to formulate queries (in the course of searching Q-A data repository) can be used, that may combine inputs from one or more of text-entry sources, voice-capturing sources, image-capturing sources, etc.

As noted, another approach for obtaining disambiguation information (e.g., in addition to using available contextual information, or when available contextual information did not sufficiently eliminate returned matches to a manageable level), is to dynamically interact with the user to solicit from the user needed disambiguation information to aid selecting one or more of the answers from the initial or remaining answers. As illustrated in FIG. 2, upon determination (at 250) of ambiguity in a set of matches for the query, a visual interaction process is executed to determine, e.g., for one or more of the ambiguous categories or concepts associated with the current set of answer matches, which value (be it an entity value, or some abstraction of the information included in the answers) matches what the user is looking for. This can be achieved by, for example:
a) Presenting to the user with the set of values and a general prompt, “please select from the following:” (“Visual form dialog”);
b) Using natural language generation techniques to create an appropriate prompt (e.g., based on identified concepts associated with the possible answers that are creating the ambiguity). For example, to disambiguate between two answers that are associated with the same (or substantially similar) concepts or categories, but have different values, the visual interaction process may generate a question to the user asking the user to provide more specificity regarding the ambiguous concept. For the example query “how do I install a browser?” that results in two possible answer matches associated with browser installation concept (one for a Mac™-based computing system, and one for a Windows™-based system) the interactive message to the user may ask the user “which computing system [or operating system] do you need to install a browser for?” Alternatively, the message to the user may list the different computing systems, and ask the user to specify which one the user needs information for. In embodiments in which there are multiple concepts/categories that are identified in the set of matches, the disambiguation process may seek to obtain disambiguation information for the most common concept determined for the multiple matches. Alternatively, other criteria, or policies, for identifying the likely concept or category to disambiguate may be used, e.g., identifying a concept, entity type, or category that can most prominently distinguish (i.e., have the greatest disambiguation impact, or highest information gain, to eliminate the most answers) between the various answers.
c) Selecting from a list of prompts that have been written in advance, for example for a chatbot in a relevant domain; and
d) Continue interacting with the user until at least some of ambiguity is resolved (e.g., some threshold number of answers is reached, or, in some examples, all ambiguity is resolved).

Thus, the dynamic interactive process, implemented by interaction block 252 (which may implement a visual interface, an audio interface, etc.) is configured to generate output data to prompt a user to provide clarification information, and select at least one of the multiple matches based, at least in part, on the clarification information provided by the user in response to the generated prompt. The interactive process configured to generate the output data to prompt the user to provide the clarification information is configured to automatically generate an output prompt based on one or more of, for example, generating a list with selectable items corresponding to different values for one or more context categories, applying natural language processing to the identified multiple matches to generate a prompt with a list of selectable items from which the user is to select one or more of the selectable items, and/or selecting from a set of pre-determined prompts one or more items.

The interactive disambiguation process (in conjunction with the query ambiguity detection process that may be implemented, in part, at the block 250 of FIG. 2) may be configured to exclude based on the clarification information provided by the user, one or more of the multiple matches. This process may be repeated until some or all of the ambiguity is resolved by iteratively generating refined output data, based on non-excluded matches from the set of identified matches, to prompt the user to iteratively provide further clarification information to identify an optimal match from the identified multiple matches. The data provided by the user through the interactive process (represented by the data block 254 in FIG. 2) is thus used to filter the content to provide the most relevant answer(s).

In some embodiments, the user's additional interactive input may include a specific selection of one of the matches presented to the user (as an intermediary set of matches or disambiguated set of matches, presented as display data 258 via a send answer to user process 256 depicted in FIG. 2), which may cause further elimination of some of the displayed matches that have conflicting concept values for the concepts associated with the selected match. The selection of a specific match can also cause a re-ranking of the displayed matches. For example, a concept(s) associated with the user-selected match that is most commonly shared with the other displayed matches is identified. The presented matches can be re-ordered or re-ranked so that matches with concept values, for the identified concept, that are closest (in a semantic or numerical way) to the concept value of the selected match, are ranked more highly then matches whose concept values for the identified concept are more distant.

The disambiguation process may be performed according to one of several possible policies. Such policies include: i) a policy that has been prefixed, i.e., what to disambiguate and the order are prefixed, ii) a policy that tries to optimize an objective function, e.g., among ambiguous concepts use the one that reduces the largest amount of entropy, or iii) a policy implementing visual displaying multiple concepts, and that lets the user decide the concepts that the user considers are more important. In some situations, different policies may be utilized at different points of execution of a query. For example, initially, upon submission of a query, the framework 200 may automatically seek to assess which contextual information (entity identifiers, abstracted concepts, etc.) might be most useful. For example, “author” context may not give much information that can be used to logically arrange the answers or to eliminate the answers. On the other hand, “operating system” may divide the initial produced answers in a 60:40 ratio. It is only after the most relevant context information (if available) is selected, that the user may be asked either in a yes/no or more open-ended questions, word cloud (size=potential importance for disambiguating), etc. Thus, in such situations, at a first stage of processing query answers, a policy that tries to optimize an objective function to reduce information entropy (e.g., policy type (ii) above) for the initially returned matches may be first applied. After the objective function policy has been applied, a policy implementing visual display of multiple concepts, to solicit disambiguating information from the user with respect to a refined set of matches, may be applied.

It is to be noted that when the user is prompted to provide selection/clarification data in response to a generated message (from the interaction process 252), the set of matches is set to be “postfiltered” so as to generate a refined set of matches (with some of the previous matches having been eliminated based on the clarification data). When the original query itself includes disambiguation data (e.g., specifying a priori values for one or more concepts or categories), the list of matches (provided in the output 242 block) may be generated based on that originally provided disambiguation data, and the resultant set of matches is said to have been “prefiltered.” At least some of the disambiguation processes, techniques, and operations for postfiltering implementations, as described herein, may also be implemented for prefiltering operations.

With reference next to FIG. 4, a flow chart of an example procedure 400 for contextual clarification and disambiguation for question answering processes is shown. The procedure includes receiving 410, at a local device (e.g., the document processing agent 110 of FIG. 1) from a remote device (e.g., a customer station, which may be physically implemented on the same computing system as the local device, but may be a logically distinct unit), query data representative of a question relating to source content of one or more source documents. The procedure 400 further includes causing a search 420 (e.g., by a third-party search engine, or by a built-in search engine available locally) of a data repository (e.g., the repository 140 of FIG. 1, or the KD repository 216 of FIG. 2) maintaining data portions relating to the one or more source documents to determine a set of multiple matches between the query data and the data portions maintained at the data repository. In some embodiments, the data portions maintained at the data repository may include transformed portions of the source content transformed according to one or more content transformation procedures. In such embodiments, causing the search of the data repository maintaining the data portions may include transforming the query data into transformed query data compatible with the transformed source content, and causing the search of the transformed content maintained at the data repository to identify one or more candidate portions in the transformed source content matching, according to one or more criteria, the transformed query data. The transformed portions of the source content include data portion transformed according to Bidirectional Encoder Representations from Transformers (BERT) processing. In some examples, the one or more transformations may include one or more of, for example, a coarse linearization transform to generate coarse numerical vectors representative of content of a plurality of document segments of the source content, or a fine-detail transformation to generate fine-detail transformed content records representative of the content of the plurality of document segments.

As further illustrated in FIG. 4, the procedure 400 further includes identifying 430 one or more concepts (e.g., abstracted categories of subject matter as determined based on ontologies used in learning machines and/or various natural language processing procedures, recognizable entities and their semantic equivalent/synonyms, etc.) associated with the multiple matches, with at least one of the one or more identified concepts being associated with at least some of multiple matches and including different respective values associated with the at least some the multiple matches. It is to be noted that in some embodiments the identifying operation may follow an initial determination that the set of matches includes multiple matches.

In response to the determination that the set of matches includes the multiple matches, the procedure 400 additionally includes obtaining 440 disambiguation information relevant to the at least one of the one or more identified concepts, and selecting 450 at least one of the multiple matches based on the obtained disambiguation information relevant to the at least one of the one or more identified concepts.

In some examples, obtaining the disambiguation information may include obtaining query contextual information for recent query transactions performed in relation to the source content. In such examples, selecting at least one of the multiple matches may include selecting at least one of the multiple matches based, at least in part, on the query contextual information for the recent query transactions performed in relation to the source content.

In some embodiments, obtaining the disambiguation information may include generating prompt data to prompt a user to provide clarification information. In such embodiments, selecting at least one of the multiple matches may include selecting at least one of the multiple matches based, at least in part, on the clarification information provided by the user in response to the generated prompt data. Generating the prompt data to prompt the user to provide the clarification information may include automatically generating an output prompt based on one or more of, for example, generating a list with selectable items corresponding to different values for one or more context categories, applying natural language processing to the identified multiple matches to generate a prompt with a list of selectable items from which the user is to select one or more of the selectable items, and/or selecting from a set of pre-determined prompts one or more items. Selecting at least one of the multiple matches may include excluding, based on the clarification information provided by the user, one or more of the multiple matches. In such embodiments, the procedure 400 may further include iteratively generating refined prompt data, based on non-excluded matches from the set of identified matches, to prompt the user to iteratively provide further clarification information to identify an optimal match from the identified multiple matches. Generating the prompt data may include rendering a graphical representation of a map to prompt the user to indicate a geographical location, and selecting the at least one of the multiple matches based, at least in part, on the clarification information, may include selecting the at least one of the multiple matches in response to the at least one of the multiple matches determined to be relevant to the geographical location indicated by the user.

In some embodiments, each of multiple matches may be associated with content contextual information associated with the data portions maintained at the data repository. In such embodiments, identifying the one or more concepts associated with the multiple matches may include identifying the one or more concepts based, at least in part, on the content contextual information associated with the each of the multiple matches. The content contextual information associated with the respective data portions may be generated by one or more of, for example, a) applying one or more pre-processes to the one or more source documents to produce document contextual information representative of a structure and content of the one or more source documents, and transforming the one or more source documents, based on the contextual information, to generate one or more question-and-answer searchable documents, b) segmenting the one or more source documents into a plurality of document segments, identifying, for at least one segment of the plurality of document segments, at least one segment descriptor comprising one or more of at least one entity associated with the at least one segment, at least one task associated with at least one segment, or subject matter descriptor associated with the at least one segment, and tagging the at least one segment with the at least one descriptor, and/or c) adding user annotations to one or more of the data portions. The content contextual information for each of the multiple matches may include data representative of values for a plurality of context categories, and identifying the one or more concepts associated with the multiple matches may include determining whether at least two of the multiple matches are associated with different values for a particular context category from the plurality of context categories. In such examples, searching the data repository to determine the set of matches between the query data and the data portions maintained at the data repository may include arranging the matches in the set of matches into groups that each share one or more of the plurality of context categories.

In some examples, the query data may include query contextual data, and causing the search of the data repository to determine the set of matches may include causing the search of the data repository to identify data portions associated with the query contextual data included in the query data. This is referred to as prefiltering operations, in which contextual data, including, for example, abstracted concepts, entity identifiers (names, locations, items), location data and other available data regarding the query, the user submitting the query, the station through which the query is being submitted, etc., can be used to aid the search to determine more relevant search results. The query contextual data may include geographical location data specified by the user through a graphical representation of a map, and selecting the at least one of the multiple matches based, at least in part, on the disambiguation information may include causing the search of the data repository to identify data portions relevant to the geographical location data specified by the user. The query contextual data may include category data specifying one or more categories from the plurality of context categories, and causing the search of the data repository may include causing the search of the data repository to identify matches associated with the specified one or more categories from the plurality of context categories specified in the query contextual data.

Obtaining the disambiguation information relevant to the at least one of the one or more identified concepts may include obtaining the disambiguation information according to one of, for example, i) a first disambiguation policy specifying a pre-determined order of multiple concepts, selected from the one or more identified concepts, for which relevance of the multiple matches to the respective multiple concepts is determined, ii) a second disambiguation policy for selecting a concept from the one or more identified concepts that optimizes an objective function to reduce level of ambiguity among the multiple matches, or iii) a third disambiguation policy to visually prompt a user for feedback related to the one or more identified concepts, for selecting the at least one of the multiple matches.

In implementations based on learning machines, different types of learning architectures, configurations, and/or implementation approaches may be used. Examples of learning machines include neural networks, including convolutional neural network (CNN), feed-forward neural networks, recurrent neural networks (RNN), etc. Feed-forward networks include one or more layers of nodes (“neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration/structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), etc.

The neural networks (and other network configurations and implementations for realizing the various procedures and operations described herein) can be implemented on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's, which can be programmed according to, for example, a CUDA C platform), and may also include special purpose logic circuitry, e.g., an FPGA (field programmable gate array), an ASIC (application-specific integrated circuit), a DSP processor, an accelerated processing unit (APU), an application processor, customized dedicated circuity, etc., to implement, at least in part, the processes and functionality for the neural network, processes, and methods described herein. The computing platforms used to implement the neural networks typically also include memory for storing data and software instructions for executing programmed functionality within the device. Generally speaking, a computer accessible storage medium may include any non-transitory storage media accessible by a computer during use to provide instructions and/or data to the computer. For example, a computer accessible storage medium may include storage media such as magnetic or optical disks and semiconductor (solid-state) memories, DRAM, SRAM, etc.

The various learning processes implemented through use of the neural networks described herein may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, etc.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Although particular embodiments have been disclosed herein in detail, this has been done by way of example for purposes of illustration only, and is not intended to be limit the scope of the invention, which is defined by the scope of the appended claims. Any of the features of the disclosed embodiments described herein can be combined with each other, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method comprising:
receiving, at a local device from a remote device, query data representative of a question relating to source content of one or more source documents;
causing a search of a data repository maintaining data portions relating to the one or more source documents to determine a set of multiple matches between the query data and the data portions maintained at the data repository;
identifying one or more concepts associated with the set of multiple matches, at least one of the one or more identified concepts being associated with at least some of the multiple matches and including different respective values associated with the at least some of the multiple matches;
obtaining disambiguation information relevant to the at least one of the one or more identified concepts; and
selecting at least one of the multiple matches based on the obtained disambiguation information relevant to the at least one of the one or more identified concepts.

2. The method of claim 1, wherein obtaining the disambiguation information comprises obtaining query contextual information for recent query transactions performed in relation to the source content;
and wherein selecting at least one of the multiple matches comprises selecting at least one of the multiple matches based, at least in part, on the query contextual information for the recent query transactions performed in relation to the source content.

3. The method of claim 1, wherein obtaining the disambiguation information comprises generating prompt data to prompt a user to provide clarification information;
and wherein selecting at least one of the multiple matches comprises selecting at least one of the multiple matches based, at least in part, on the clarification information provided by the user in response to the generated prompt data.

4. The method of claim 3, wherein generating the prompt data to prompt the user to provide the clarification information comprises automatically generating an output prompt based on one or more of:
generating a list with selectable items corresponding to different values for one or more context categories;
applying natural language processing to the identified multiple matches to generate a prompt with a list of selectable items from which the user is to select one or more of the selectable items; or
selecting from a set of pre-determined prompts one or more items.

5. The method of claim 3, wherein selecting at least one of the multiple matches comprises excluding, based on the clarification information provided by the user, one or more of the multiple matches;
wherein the method further includes iteratively generating refined prompt data, based on non-excluded matches from the set of identified matches, to prompt the user to iteratively provide further clarification information to identify an optimal match from the identified multiple matches.

6. The method of claim 3, wherein generating the prompt data comprises rendering a graphical representation of a map to prompt the user to indicate a geographical location;
and wherein selecting the at least one of the multiple matches based, at least in part, on the clarification information comprises selecting the at least one of the multiple matches in response to the at least one of the multiple matches determined to be relevant to the geographical location indicated by the user.

7. The method of claim 1, wherein each of multiple matches is associated with content contextual information associated with the data portions maintained at the data repository;
wherein identifying the one or more concepts associated with the multiple matches comprises identifying the one or more concepts based, at least in part, on the content contextual information associated with the each of the multiple matches.

8. The method of claim 7, wherein the content contextual information associated with the respective data portions is generated by one or more of:
a) applying one or more pre-processes to the one or more source documents to produce document contextual information representative of a structure and content of the one or more source documents, and transforming the one or more source documents, based on the contextual information, to generate one or more question-and-answer searchable documents;
b) segmenting the one or more source documents into a plurality of document segments, identifying, for at least one segment of the plurality of document segments, at least one segment descriptor comprising one or more of at least one entity associated with the at least one segment, at least one task associated with at least one segment, or subject matter descriptor associated with the at least one segment, and tagging the at least one segment with the at least one descriptor; or
c) adding user annotations to one or more of the data portions.

9. The method of claim 7, wherein the content contextual information for each of the multiple matches includes data representative of values for a plurality of context categories;
and wherein identifying the one or more concepts associated with the multiple matches comprises:
determining whether at least two of the multiple matches are associated with different values for a particular context category from the plurality of context categories.

10. The method of claim 9, wherein causing the search of the data repository to determine the set of matches between the query data and the data portions maintained at the data repository comprises:
arranging the matches in the set of matches into groups that each share one or more of the plurality of context categories.

11. The method of claim 7, wherein the query data comprises query contextual data;
and wherein causing the search of the data repository to determine the set of matches comprises causing the search of the data repository to identify data portions associated with the query contextual data included in the query data.

12. The method of claim 11, wherein the query contextual data comprises geographical location data specified by a user through a graphical representation of a map;
and wherein selecting the at least one of the multiple matches based, at least in part, on the disambiguation information comprises causing the search of the data repository to identify data portions relevant to the geographical location data specified by the user.

13. The method of claim 11, wherein the query contextual data includes category data specifying one or more categories from a plurality of context categories;
and wherein causing the search of the data repository comprises causing the search of the data repository to identify matches associated with the specified one or more categories from the plurality of context categories specified in the query contextual data.

14. The method of claim 1, wherein the data portions maintained at the data repository comprise transformed portions of the source content transformed according to one or more content transformation procedures, and wherein causing the search of the data repository maintaining the data portions comprises:
transforming the query data into transformed query data compatible with the transformed source content; and
searching the transformed content maintained at the data repository to identify one or more candidate portions in the transformed source content matching, according to one or more criteria, the transformed query data.

15. The method of claim 14, wherein the transformed portions of the source content include data portion transformed according to Bidirectional Encoder Representations from Transformers (BERT) processing.

16. The method of claim 14, wherein the one or more transformations comprise one or more of: a coarse linearization transform to generate coarse numerical vectors representative of content of a plurality of document segments of the source content, or a fine-detail transformation to generate fine-detail transformed content records representative of the content of the plurality of document segments.

17. The method of claim 1, wherein obtaining the disambiguation information relevant to the at least one of the one or more identified concepts comprises:
obtaining the disambiguation information according to one of:
i) a first disambiguation policy specifying a pre-determined order of multiple concepts, selected from the one or more identified concepts, for which relevance of the multiple matches to the respective multiple concepts is determined;
ii) a second disambiguation policy for selecting a concept from the one or more identified concepts that optimizes an objective function to reduce level of ambiguity among the multiple matches; or
iii) a third disambiguation policy to visually prompt a user for feedback related to the one or more identified concepts, for selecting the at least one of the multiple matches.

18. A system comprising:
a communication unit configured to receive, from a remote device, query data representative of a question relating to source content of one or more source documents; and
a controller electrically coupled to the communication unit, the controller configured to:
cause a search of a data repository maintaining data portions relating to the one or more source documents to determine a set of multiple matches between the query data and the data portions maintained at the data repository;
identify one or more concepts associated with the multiple matches, at least one of the one or more identified concepts being associated with at least some of the multiple matches and including different respective values associated with the at least some of the multiple matches;
obtain disambiguation information relevant to the at least one of the one or more identified concepts; and
select at least one of the multiple matches based on the obtained disambiguation information relevant to the at least one of the one or more identified concepts.

19. The system of claim 18, wherein the controller configured to obtain the disambiguation information is configured to obtain query contextual information for recent query transactions performed in relation to the source content;
and wherein the controller configured to select at least one of the multiple matches is configured to select at least one of the multiple matches based, at least in part, on the query contextual information for the recent query transactions performed in relation to the source content.

20. The system of claim 18, wherein the controller configured to obtain the disambiguation information is configured to generate prompt data to prompt a user to provide clarification information;
and wherein the controller configured to select at least one of the multiple matches is configured to select at least one of the multiple matches based, at least in part, on the clarification information provided by the user in response to the generated prompt data.

21. The system of claim 20, wherein the controller configured to generate the prompt data to prompt the user to provide the clarification information is configured to automatically generate an output prompt based on one or more of:
generating a list with selectable items corresponding to different values for one or more context categories;
applying natural language processing to the identified multiple matches to generate a prompt with a list of selectable items from which the user is to select one or more of the selectable items; or
selecting from a set of pre-determined prompts one or more items.

22. The system of claim 20, wherein the controller configured to select at least one of the multiple matches is configured to exclude, based on the clarification information provided by the user, one or more of the multiple matches;
wherein the controller is further configured to iteratively generate refined prompt data, based on non-excluded matches from the set of identified matches, to prompt the user to iteratively provide further clarification information to identify an optimal match from the identified multiple matches.

23. The system of claim 20, wherein the controller configured to generate the prompt data is configured to render a graphical representation of a map to prompt the user to indicate a geographical location;
and wherein the controller configured to select the at least one of the multiple matches based, at least in part, on the clarification information is configured to select the at least one of the multiple matches in response to the at least one of the multiple matches determined to be relevant to the geographical location indicated by the user.

24. The system of claim 18, wherein each of multiple matches is associated with content contextual information associated with the data portions maintained at the data repository;
wherein the controller configured to identify the one or more concepts associated with the multiple matches is configured to identify the one or more concepts based, at least in part, on the content contextual information associated with the each of the multiple matches.

25. The system of claim 24, wherein the content contextual information associated with the respective data portions is generated by one or more of:
a) applying one or more pre-processes to the one or more source documents to produce document contextual information representative of a structure and content of the one or more source documents, and transforming the one or more source documents, based on the contextual information, to generate one or more question-and-answer searchable documents;
b) segmenting the one or more source documents into a plurality of document segments, identifying, for at least one segment of the plurality of document segments, at least one segment descriptor comprising one or more of at least one entity associated with the at least one segment, at least one task associated with at least one segment, or subject matter descriptor associated with the at least one segment, and tagging the at least one segment with the at least one descriptor; or
c) adding user annotations to one or more of the data portions.

26. The system of claim 24, wherein the content contextual information for each of the multiple matches includes data representative of values for a plurality of context categories;
and wherein the controller configured to identify the one or more concepts associated with the multiple matches is configured to:
determine whether at least two of the multiple matches are associated with different values for a particular context category from the plurality of context categories.

27. The system of claim 26, wherein the controller configured to cause the search of the data repository to determine the set of matches between the query data and the data portions maintained at the data repository is configured to:
arrange the matches in the set of matches into groups that each share one or more of the plurality of context categories.

28. The system of claim 24, wherein the query data comprises query contextual data;
and wherein the controller configured to cause the search of the data repository to determine the set of matches is configured to cause the search of the data repository to identify data portions associated with the query contextual data included in the query data.

29. The system of claim 18, wherein the controller configured to obtain the disambiguation information relevant to the at least one of the one or more identified concepts is configured to:
obtain the disambiguation information according to one of:
i) a first disambiguation policy specifying a pre-determined order of multiple concepts, selected from the one or more identified concepts, for which relevance of the multiple matches to the respective multiple concepts is determined;
ii) a second disambiguation policy for selecting a concept from the one or more identified concepts that optimizes an objective function to reduce level of ambiguity among the multiple matches; or
iii) a third disambiguation policy to visually prompt a user for feedback related to the one or more identified concepts, for selecting the at least one of the multiple matches.

30. A non-transitory computer readable media programmed with instructions, executable on one or more processors of a computing system, to:
receive, at a local device from a remote device, query data representative of a question relating to source content of one or more source documents;
cause a search of a data repository maintaining data portions relating to the one or more source documents to determine a set of multiple matches between the query data and the data portions maintained at the data repository;
identify one or more concepts associated with the multiple matches, at least one of the one or more identified concepts being associated with at least some of the multiple matches and including different respective values associated with the at least some of the multiple matches;
obtain disambiguation information relevant to the at least one of the one or more identified concepts; and
select at least one of the multiple matches based on the obtained disambiguation information relevant to the at least one of the one or more identified concepts.
